(19) United States
(12) Patent Application Publication
(10) Pub. No.: US 2026/0153320 A1
(43) Pub. Date: Jun. 4, 2026

(54) HEAD HEIGHT & MATERIAL MEASUREMENT

(71) Applicant: Atlas Copco IAS UK Limited, Flintshire (GB)

(72) Inventors: Norbert Collomb, Flintshire (GB); Andrew Litherland, Flintshire (GB); Daniel Haoyu Tang, Flintshire (GB); Peter John Elliot, Flintshire (GB); Elliot Jones, Flintshire (GB); Wesley Stocker, Flintshire (GB); Andreas Wenzel, Flintshire (GB); Eugen Schaal, Flintshire (GB)

(21) Appl. No.: 19/124,109

(22) PCT Filed: Oct. 27, 2023
(86) PCT No.: PCT/GB2023/052808

§ 371 Date: Apr. 24, 2025

(30) Foreign Application Priority Data
Nov. 1, 2022 (GB) 2216238.2

(51) Int. Cl. G01B 5/14; B21J 15/04; G01B 5/06

(52) U.S. Cl. CPC G01B 5/14; B21J 15/04; G01B 5/061

(57) ABSTRACT

A computer-implemented method of determining a property of a fastener. The method comprising receiving a stored deflection factor, the stored deflection factor relating a deflection of a fastener setting tool to the peak force exerted by the fastener on a die. The method further comprising receiving a determined peak force, the determined peak force corresponding to the peak force exerted by a punch of the fastener setting tool on the fastener. The method further comprising receiving a determined thickness of a work piece, receiving a determined position of a top surface of the fastener; and determining the head height of the fastener.

### FIELD

The present invention relates to a computer-implemented method of determining a property of a fastener and a computer-implemented method of determining a property of a work piece and/or a fastener setting tool.

### BACKGROUND

Fasteners, for example self-piercing rivets, may be inserted into a work piece to mechanically fix panels of the work piece together. Self-piercing rivets may also be referred to as self-inserting rivets. The work piece may comprise two or more panels. The work piece may further comprise an inter-layer substance (e.g. adhesive, sealant and/or foil) provided between two adjacent panels. As an example, the work piece may comprise aluminium panels which may form part of a car or another vehicle.

A fastener may be inserted using a fastener setting tool. The fastener setting tool typically punches the fastener into the work piece while the work piece is supported by a die. In the example of a self-piercing rivet, the self-piercing rivet may flare in a radially outwards manner to enable the panels of the work piece to be fixed together. A surface of the die that supports the work piece may be provided with a shape to encourage flaring of the self-piercing rivet.

Similar work pieces may not be identical. For example, work pieces from a single batch corresponding to a part of a product may each vary from a nominal work piece by a different amount. In other words, while a thickness of a nominal work piece may be known, a thickness of each work piece may not be known without measuring each work piece separately. Other properties, for example, strength or ductility of a work piece may also not be known without measuring each work piece separately. Measuring each component (i.e. each panel and, optionally, each inter-layer substance) of each work piece separately or each work piece separately may add an additional step to a construction process and therefore may slow the construction process.

The fastener may be inserted into the work piece with a pre-determined speed and force to achieve a required depth of insertion (of the fastener). After being inserted into a surface of the work piece, a head height of the fastener (i.e. a position of a top surface of a fastener relative to a top surface of the work piece in a region close to the fastener) may indicate a property of a joint made by the fastener. Without destructive testing, the head height may be the only indication of the strength of the joint. Measuring the head height in a conventional manner may add one or more additional steps to a construction process and therefore may slow the construction process.

Using an inertial fastener setting tool, an amount of energy available to provide to a fastener has a contribution from an inertia of a flywheel, a linear momentum of the tool and a torque provided by a motor. The amount of energy available to be provided to a fastener may be reduced by frictional losses within the tool. The frictional losses may vary depending on a condition of the tool. Conditions may include, for example, temperature, age, fastener characteristics, work piece characteristics, previous usage of tool, lubrication characteristics (e.g. an amount of lubrication, a temperature of lubrication), and others.

A tool may be in a ‘cold’ state. A tool may be cold when at a temperature below a desired operating temperature. A tool may be cold when an insertion cycle has not been performed recently. Being in a cold state may result in the tool having increased internal friction, for example due to lubrication being at a sub-optimal temperature (i.e. cold) and/or due to other factors such as the tool being used with new, worn or damaged parts/components.

Alternatively, a tool may be in a ‘warm’ state. A tool may be warm when at a desired operating temperature. A tool may be warm when sufficient insertion cycles have been performed recently, for example within the last 15 minutes. Being in a warm state may result in the tool having reduced internal friction, for example due to lubrication being at an optimal temperature (i.e. warm) and/or due to other factors such as the tool being used with parts/components which are not new, worn or damaged.

Alternatively, a tool may be ‘warming’. A warming tool may be between ‘cold’ and ‘warm’ states and the operating temperature may be increasing.

Cold and/or warming tools may experience greater internal friction compared to warm tools. The increased internal friction may be due to viscosity changes in lubrication and/or movement and location of lubrication within in the tool, as well as changes in internal component condition. As such, it is beneficial to operate a warm tool as less driving force is required compared to a cold or warming tool. However, it is necessary to use a cold or warming tool, for example as a tool will be cold when it is initially used. In such cases, it may be beneficial to compensate for frictional losses

When a tool is riveting a work piece (or a type of work piece) for a first time, parameters (e.g. force) for use by the tool are often chosen by an engineer operating the tool. For example, the parameter may be chosen based on experience of the engineer. The parameters may be input to the tool by use of a human-machine interface (HMI). It is possible that the parameters are not optimal. For example, more or less force (than the force chosen by the engineer) may be needed for certain work pieces to achieve a joint with the required properties. Despite the use of excessive force, the joint formed by the tool in the work piece may appear satisfactory. That is, the die may hold an expected work piece volume, panel gaps may be closed and the fastener head may be flush. However, such a joint may have been formed by the use of more force than necessary. Using excessive force in this way may reduce the lifetime of the tool and the components thereof. For example, a punch and/or a blank holder may experience excess wear due to the use of excess force.

It is unlikely that the use of excessive force will be detected by the engineer operating the tool. This may the case regardless of the setter technology or the method used to apply the force (i.e. whether hydraulic, electric, or pneumo-hydraulic systems are used). This is because once a die is filled and the fastener head height is flush, more force may be applied without changing a resulting head height. In other words, a head height of a fastener after an optimum amount of force has been applied by the tool may be the same as a head height of a fastener after an excessive amount of force has been applied by the tool. While force has been discussed as an example of the parameter, similar considerations apply to other examples, such as an energy applied by the tool or a velocity at which the tool is operated.

It is an object of the present invention to overcome or mitigate one or more of these problems.

### SUMMARY

In a first example described herein, there is a computer-implemented method of determining a property of a fastener, the method comprising: receiving a stored deflection factor, the stored deflection factor relating a deflection of a fastener setting tool to the peak force exerted by the fastener on a die; receiving a determined peak force, the determined peak force corresponding to the peak force exerted by a punch of the fastener setting tool on the fastener; receiving a determined thickness of a work piece; receiving a determined position of a top surface of the fastener; and determining the head height, HH, of the fastener as:

$$HH = ( DF \times PF ) - MT + ED$$

wherein: DF is the stored deflection factor; PF is the determined peak force; MT is the determined thickness of the work piece; and ED is the determined position of the top surface of the fastener.

Beneficially the method may allow determination of the head height of a fastener without measuring the head height itself. The head height of a fastener may be indicative of a property of the work piece. The head height may also be referred to as the position of a top surface of a head of the fastener relative to a top surface of the work piece in a region close to the fastener. The region close to the fastener may be immediately surrounding the fastener or may be a region beyond a region that has been deformed due to the fastener being inserted.

The determined head height of the fastener may provide an indication of a strength (or another property) of a joint (i.e. the joint made by the fastener) as an alternative to (or in addition to) destructive testing. For example, a head height of a first joint in a first work piece may be determined and a strength first joint may be determined using destructive testing. A head height of a second joint in a second work piece may be determined and used to infer the strength of the second joint based on the head height and strength of the first joint.

The fastener may be a rivet, for example, a self-piercing rivet. The blank holder may also be referred to as a work piece holder or a nose. The die may be configured to prevent the work piece from moving under a force applied to the work piece. The die may also be referred to as an anvil.

The position of the top surface of the fastener may be determined by measuring using a first sensor, measuring using a second sensor or determined through use of an encoder. For example, a velocity of the punch as a function of time may be recorded and used to determine a maximum displacement of the punch and the determined maximum displacement of the punch may be used to determine the position of the top surface of the fastener.

Determining the peak force exerted by the punch on the fastener may comprise use of a force sensor, for example, a force sensor provided in the punch. Alternatively, the force may be determined through use of an encoder to measure the motor torque applied to the punch.

The top surface of the fastener may be a surface of the fastener opposed to and/or contacted by the punch. The top surface of the fastener may be a surface of the fastener closest to the blank holder when the blank holder is in a retracted position.

The deflection of the fastener setting tool may be a deflection of the die from the first position to a second position due to a force exerted by the fastener setting tool. The deflection factor may be related to a location of the fastener in the work piece and/or similar work pieces. In other words, if the fastener was inserted in a different location in the work piece a different deflection factor may be received. If the fastener was inserted in a similar location in a similar work piece, the same deflection factor may be received. Alternatively, the deflection factor may be consistent across a work piece and/or similar work pieces.

Receiving the determined thickness of the work piece may further comprise: causing a blank holder of the fastener setting tool to advance such that the blank holder moves to a calibration position; measuring, with a first sensor configured to measure a displacement of the blank holder, a position of the calibration position along an axis travelled by the blank holder; causing the blank holder to advance such that the blank holder contacts a surface of the work piece and clamps the work piece against the die; measuring, with the first sensor, a position of the surface of the work piece along the axis travelled by the blank holder; and determining, using the measured position of the calibration position and the measured position of the surface of the work piece, a thickness of the work piece.

Advantageously, use of the calibration position may improve an accuracy of the measurement.

The calibration position may be a position of the blank holder when the blank holder has contacted a surface of the die. In other words, the calibration position may be a first position of the die and/or the measured position of the calibration position may be a first measured position of the surface of the die. Alternatively, the calibration position may be a position of the blank holder when the blank holder has contacted a surface of a calibration member that has been placed on the die. For example, the calibration member may be a nominal work piece and/or have a width the same as an expected width of the work piece.

The method may further comprise causing the blank holder to retract such that a work piece may be inserted between the blank holder and the die.

Once the blank holder has contacted the surface of the work piece the blank holder may clamp the work piece against the die.

The measured position of the calibration position may be expressed as the distance travelled by the blank holder in order for the blank holder to move to the calibration position. Likewise, the measured position of the surface of the work piece may expressed as the distance travelled by the blank holder in order for the blank holder to contact the surface of the work piece.

The determined thickness of the work piece may be determined relative to the calibration position. In the example in which the calibration position is the first position of the die, the determined thickness of the work piece may be a thickness of the work piece (i.e. an absolute thickness). For example, the work piece may be determined as 5.6 mm thick. In the example in which the calibration position is the position of the blank holder when the blank holder contacts the surface of the calibration member, the determined thickness of the work piece may be determined relative to the thickness of the calibration member (i.e. a relative thickness). For example, the determined thickness may be 1 mm thicker than the thickness of the calibration member.

The determined position of the top surface of the fastener may be determined relative to the calibration position. In examples in which the calibration position is the surface of the die, the determined position of the top surface of the fastener may be determined relative to the measured position of the surface of the die.

The method may further comprise receiving the thickness of the calibration member and determining the absolute thickness of the work piece using the determined thickness of the work piece relative to the thickness of the calibration member. In other words, an absolute thickness may be determined from a relative thickness. For example, the determined thickness relative to the calibration member may be 1 mm thick (i.e. 1 mm thicker than the calibration member) and the calibration member thickness of 4.6 mm may be received, and the absolute thickness of the work piece may be determined as 5.6 mm.

The method may further comprise applying a threshold test to the determined head height.

A binary result may be provided from the threshold test. For example, the threshold test may be 5 mm (or less) and the determined head height may be 5.6 mm and the threshold test may provide a result of 0 to indicate the threshold test was failed. Alternatively, for a determined head height of 4.6 mm, the same threshold test may provide a result of 1 to indicate the threshold test was passed. As an alternative, the threshold test may test if the determined head height is more, equal to or more, or less than or equal to a threshold value. The results of the threshold test may be expressed as warning indicators and/or fault indicators.

The method may comprise applying a threshold test or a plurality of threshold tests to the determined head height. In other words, the threshold test may be one of a plurality of threshold tests. Each test may correspond to a respective condition.

In a second example described herein there is a computer-implemented method of determining a property of a work piece and/or a fastener setting tool, the method comprising: causing a blank holder of the fastener setting tool to advance such that the blank holder moves to a calibration position; measuring, with a first sensor configured to measure a displacement of the blank holder, a position of the calibration position along an axis travelled by the blank holder; causing the blank holder to advance such that the blank holder contacts a surface of the work piece and clamps the work piece against the die; measuring, with the first sensor, a position of the surface of the work piece; determining, using the measured position of the calibration position and the measured position of the surface of the work piece, a thickness of the work piece.

The property of the work piece may comprise a property of a joint made in the work piece.

Likewise to the first example, the method may further comprise applying a threshold test to the determined thickness of the work piece. The method may further comprise determining, based on a result of the threshold test, the fastener setting tool requires maintenance; determining, based on a result of the threshold test, that the work piece should be reviewed and/or replaced; and/or determining, based on a result of the threshold test, that a parameter associated with the fastener setting tool should be adjusted.

The method may further comprise causing the blank holder to retract such that the work piece may be inserted between the blank holder and the die.

The method may further comprise: receiving a determined position of a top surface of the fastener; receiving a measured head height of the fastener; determining a tool deflection, TD, corresponding in changes in end positions relative to starting positions of components of the tool due to insertion of the fastener as:

$$TD = HH + MT - ED$$

wherein: HH is the measured head height of the fastener; MT is the determined thickness of the work piece; and ED is the determined position of the top surface of the fastener.

The measured head height may be measured manually, for example, by an operator of the fastener setting tool using a dial test indicator. The fastener may be the fastener inserted into the work piece.

The method may further comprising storing the determined tool deflection. For example, the tool deflection may be stored in computer readable memory.

The method may further comprise: determining a peak force exerted by the punch on the fastener; and determining a deflection factor, DF, corresponding to a deflection of the fastener setting tool to the peak force exerted by the punch on the fastener as:

$$DF = TD \div PF$$

wherein PF is the determined peak force.

Beneficially, the deflection factor may allow determination of the head height of fasteners without measuring the head height itself.

The deflection factor and/or the tool deflection may be dependent on the location of a joint (i.e. the joint made by the fastener in the work piece). In other words, the deflection factor and/or the tool deflection may be determined for the location of the joint. If a property of the joint is changed (for example, the location, the work piece or the fastener is changed), a new deflection factor and/or tool deflection may be determined. The location of joint may apply to a single work piece or a plurality of work pieces having joints in corresponding locations.

The method may further comprise storing the deflection factor. For example, the deflection factor may be stored in computer readable memory.

The method may further comprise applying a threshold test to the determined property. For example, the threshold test may be applied to the deflection factor, the tool deflection and the thickness of the work piece.

In a third example described herein there is a computer-implemented method for determining a property of a work piece or a joint made in the work piece, the method comprising: causing a blank holder of a fastener setting tool to contact a surface of the work piece; causing a force to be applied to the blank holder in a direction axial to the blank holder towards the work piece; detecting, by measuring a displacement of the blank holder, movement of the work piece; and determining, based on the detected movement, the property of the work piece or joint made in the work piece.

The method may further comprising determining predetermined features are present in the detected movement. The predetermined features may comprise, for example, consistent movement of panels of the work piece in a single direction. In other words, two or more panels of the work piece may gradually move together under the force applied by the blank holder i.e. the two or more panels may be squeezed together.

The predetermined features may comprise, for example, oscillations of one or more panels. In other words, one or more panels may move back and forth in response to a perturbation provided by the force applied by the blank holder.

The movement of the work piece may be in response to the force applied by the blank holder. Additionally or alternatively, the movement of the work piece may be in response to a fastener being inserted by a punch of the fastener setting tool.

Detection of the two or more panels being squeezed together may indicate that panel gaps were present in the work piece prior to being squeezed together. Additionally or alternatively, detection of the two or more panels being squeezed together may indicate the presence of adhesive and/or the amount of adhesive present.

Detection of oscillations may indicate a brittleness of panels of the work piece.

The property of the work piece may be a property of a panel of the work piece, for example, an upper most panel. In other words, the property may be a property of the panel closest to the blank holder.

The method may further comprise applying a threshold test to the determined property.

Any of the methods may further comprise causing a punch of the fastener setting tool to insert a fastener into the work piece. In other words, the fastener may make a joint in the work piece. The fastener may be a first fastener. It will be appreciated that the insertion may be successful or unsuccessful. Further, the fastener may be fully inserted or partially inserted after the insertion.

The property may be distortion of the work piece (or panels in the work piece).

Any of the methods may further comprise determining, based on a result of the threshold test, the fastener setting tool requires maintenance.

Any of the methods may further comprise indicating to a user that maintenance is required and/or the method may further comprise carrying out the maintenance. The method may further comprise determining, based on a result of the threshold test, the fastener setting tool does not require maintenance.

In examples in which the method comprises a plurality of threshold tests, determining that the fastener setting tool requires maintenance and/or determining that the fastener setting tool does not require maintenance may be based on the result of one or more of the plurality of threshold tests. The method may further comprise providing an indication that maintenance is required, scheduling maintenance and/or causing maintenance to be performed.

Any of the methods may further comprise determining, based on a result of the threshold test, that the work piece should be replaced.

In other words, the method may identify that the work piece is not of suitable for use in a process and/or product. For example, the work piece may be too brittle, too ductile, too thick, too thin and/or too hard for the intended use of the work piece. The method may further comprise providing an indication that the work piece should be replaced and/or causing the work piece to be replaced.

Any of the methods may further comprise determining, based on a result of the threshold test, that a parameter associated with the fastener setting tool should be adjusted.

In other words, the method may identify that a joint (i.e. the joint made by the fastener in the work piece) may be improved by changing a parameter associated with the fastener setting tool. For example, the force applied to the fastener by the punch and/or the velocity of the punch may be adjusted. The method may further comprise providing an indication that the parameter should be adjusted and/or causing the parameter to be adjusted. The parameter may be adjusted such that the fastener setting tool uses the adjusted parameters to insert the fastener (i.e. continue/complete the insertion of the fastener). Additionally or alternatively, the parameter may be adjusted such that the fastener setting tool uses the adjusted parameter to insert a subsequent fastener into the same work piece and/or a subsequent work piece. As an example of a parameter that may be adjusted, a type of rivet inserted may be changed.

Measuring the displacement of the blank holder may comprise measuring the displacement of a member of the fastener setting tool fixed relative to the blank holder. Such a method allows for measurement of the displacement of the blank holder without measuring the blank holder position directly. Accordingly, sensors do not need to be provided in a region near the blank holder. Advantageously, measuring the position of the blank holder relative to a calibration position may reduce the length of the member needed to measure the displacement of the blank holder. Beneficially, this may also reduce a space occupied by the blank holder, thereby improving access to the work piece in an industrial production setting. Beneficially by not needing to provide sensors in a region near the blank holder, the sensors may be kept away from areas which have greater exposure to debris, dust, and/or damage and therefore improving potential life of the sensors and reducing need for service. For example, measuring the position of the calibration position may comprise measuring a first position of the member (i.e. the position of the member when the blank holder is in the calibration position). As another example, measuring the position of the surface of the work piece may comprises measuring a second position of the member (i.e. the position of the member when the blank holder contacts the surface of the work piece).

The method of any of the previous examples may further comprise comparing the determined property to a predetermined property, wherein a difference between the determined property and the predetermined property represents a condition of the fastener setting tool or the work piece; calculating an adjustment based on the comparison to compensate for the condition of the fastener setting tool or the work piece; and applying the adjustment to the fastener setting tool and/or the work piece.

The performance of a fastener setting tool may vary depending on the condition of the tool, for example if the tool is cold, warming or warm. By using this method, the varying performance of the tool may be compensated for. In particular, an effect of frictional losses can be indirectly determined by measuring the first parameter and comparing it to the predetermined parameter. Calculating and applying an adjustment thereon therefore provides a compensation method. Such a compensation method may beneficially improve the performance of the tool.

An energy consumption and/or a wear rate of the fastener setting tool may vary depending on the conditions of the tool, for example, depending on a target parameters set for the tool. Example target parameters may comprise force and/or energy. As described above, once sufficient force is applied to the tool such that the die is filled, applying additional (i.e. excessive) force may not change the head height. By using this method, an optimum head height may be achieved with a minimal force and/or a minimal energy consumption. Such a compensation method may beneficially save energy and improve the lifetime of the tool and components thereof.

The determined property may be, for example, the determined head height of the first fastener. As an alternative example, the property may be a deflection factor.

The predetermined property may have been determined at any earlier point in time. For example, the predetermined property may be loaded from a database. As an alternative example, the predetermined property may have been determined based on insertion of a previous fastener.

The condition of the fastener setting tool may be, or comprise, a temperature, age, previous usage of tool, lubrication characteristics (e.g. amount of lubrication, temperature of lubrication), and others. The condition of the work piece may be, or comprise, a strength, ductility or a property of a fastener.

The method may be performed iteratively to form a feedback loop. The steps of comparing, calculating, and applying an adjustment may be repeated any number of times for the same or successive fasteners. In this way, the method may converge on parameters for inserting a fastener to help minimize tool wear while ensuring that fasteners are inserted in accordance with predetermined properties.

In some examples, the adjustment may be applied automatically. That is, the fastener setting tool may apply the adjustment without any further input. In other examples, the method may further comprise outputting, on an output of the fastener setting tool, an indication of the adjustment. The method may further comprise receiving, at an input of the fastener setting tool, user input instructing the fastener setting tool to apply the adjustment and the adjustment may be applied in response to the user input.

The determined property may be based on a plurality of measurements. For example, the determined property may be an average of determined head heights, each determined head height corresponding to a different fastener.

Comparing the determined property to the predetermined property, calculating the adjustment based on the comparison, and applying the adjustment may each be performed after the punch has been caused to insert the first fastener into the work piece. The method may further comprise, after the adjustment has been applied, causing the punch to insert a second fastener into a work piece. In other words, the fastener setting tool may insert the first fastener with a first set of parameters and, based on the comparison, may insert the second fastener with a second set of parameters. Additionally or alternatively, the method may further comprise, after the adjustment has been applied, causing the punch to further insert the first fastener into the work piece. In other words, the fastener setting tool may insert the first fastener with a first set of parameters and, based on the comparison, may further insert the first fastener with a second set of parameters. Put differently, the adjustment may be applied while the first fastener is being inserted.

The adjustment may be an adjustment to a torque and/or force applied by the fastener setting tool. For example, the head height of the first fastener may be greater than the required head height. In response, the fastener setting tool may apply higher torque and/or force when further inserting the first fastener and/or inserting the second fastener. As an alternative, the head height of the first fastener may be less than the required head height. In response, the fastener setting tool may apply less torque and/or force when inserting the second fastener. The torque of a motor may correspond to a motor speed or an electrical stimulation provided to the motor.

The adjustment may be an adjustment to a velocity of the fastener setting tool. For example, the velocity may be a target velocity at which the punch of the fastener setting tool operates. Accordingly, the fastener inserting tool may insert fasteners at an optimum velocity. The optimum velocity may be a fastest velocity that results in a correctly inserted fastener (i.e. without any over-insertion). Beneficially, such adjustments may allow a manufacturing process to be sped up.

In some examples, the punch of the fastener setting tool may be configured to operate at a first velocity while in a first region and at a second velocity while in a second region. In particular, the punch may operate at a higher velocity when in the first region further away from the fastener that is to be inserted and at a lower velocity when in the second region closer to the fastener. In other words, the punch may be operated at a fly across space velocity. In such examples, the adjustment may be to first velocity and/or the second velocity.

The method of any of any of the previous examples may further comprise comparing the determined property to a predetermined property, wherein a difference between the determined property and the predetermined property represents a condition of the fastener setting tool and/or the work piece; and determining, based on the comparing, that no adjustment to the fastener setting tool and/or work piece is required.

The determined property may be the determined head height of the first fastener; and the predetermined property may be a predetermined head height.

The determined property may be the determined thickness of the work piece; and the predetermined property may be a predetermined thickness.

The determined property may be the determined tool deflection; and the predetermined property may be a predetermined tool deflection.

The determined property may be the determined deflection factor; and the predetermined property is a predetermined deflection factor.

In a fourth example described herein there is a computer-implemented method of determining a force for inserting a fastener into a work piece using a fastener setting tool, the method comprising: receiving a required head height of the fastener; receiving a thickness of a work piece; receiving a deflection factor; receiving a desired position of the top surface of the fastener; determining a force PF, to apply to the fastener by a punch of the fastener setting tool as:

$$PF = \frac{HH + MT - ED}{DF}$$

wherein: HH is the required head height of the fastener; DF is the deflection factor; MT is the thickness of the work piece; and ED is the position of the top surface of the fastener.

The method may further comprise inserting the fastener into the work piece using a fastener setting tool with the determined force.

In a fifth example described herein there is a fastener setting tool configured for use in the method of any preceding examples.

In a sixth example described herein there is a controller for a fastener setting tool, wherein the controller is configured to perform the method of any one of the first to fifth examples.

In a seventh example described herein there is a fastener setting tool comprising a first sensor configured to measure a displacement of a blank holder.

The fastener setting tool may further comprise a member fixed relative to the blank holder. The first sensor may be configured to measure a displacement of the member.

The first sensor may be a contact displacement sensor.

It will be appreciated that a reference to any one of: receiving a quantity; determining a quantity; and measuring a quantity be construed likewise. For example, receiving a determined position of a top surface of the fastener may comprise determining a position of the top surface of the fastener and/or measuring the position of the top surface of the fastener.

It will be also appreciated that the steps of any of the methods may be carried out in any appropriate order. For example, in the method of the first example, the position of the surface of the work piece may be received prior to receiving the position of the calibration position.

### BRIEF DESCRIPTION OF THE DRAWINGS

Embodiments of the invention will now be described, by way of example only, with reference to the following drawings, in which:

FIG. 1 is a side view of an example rivet-setting tool;

FIG. 2 is a flow diagram depicting a method of determining a thickness of a work piece;

FIGS. 3A-3F schematically illustrate a system comprising a rivet-setting tool during the method of determining a thickness of a work piece;

FIG. 4 is a flow diagram depicting a method of determining a tool deflection;

FIG. 5 is a flow diagram depicting a method of determining a head height of a fastener;

FIG. 6 is a flow diagram depicting a method of determining a force for inserting a fastener;

FIG. 7 is a flow diagram depicting a method of determining a property of a work piece or a joint made in a work piece;

FIG. 8 is a flow diagram depicting a method of calculating and applying an adjustment to a fastener setting tool and/or a work piece;

FIG. 9 is a flow diagram depicting a method of determining that no adjustment to a fastener setting tool and/or work piece is required;

FIG. 10 is a flow diagram depicting an iterative method of calculating and applying adjustments to a fastener setting tool and/or a work piece; and

FIG. 11 depicts an example computer system that may be used to perform the methods described herein.

### DETAILED DESCRIPTION

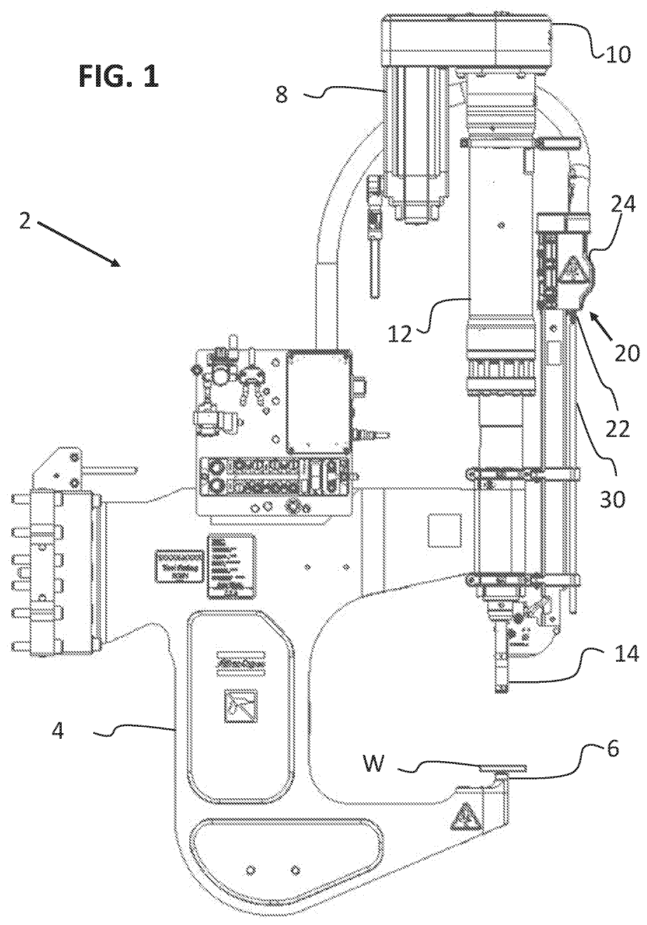

FIG. 1 depicts in side view a rivet insertion tool 2. The rivet insertion tool 2 (which may also be referred to as a fastener setting tool or a rivet setting tool) is mounted on an upper arm of a conventional C-frame 4. A die 6 is mounted on a lower arm of the C-frame 4 using associated mounting components (e.g. a die holder). The die 6 may also be referred to as an anvil. A work piece W into which a self-piercing rivet will be inserted is positioned between the blank holder 14 and the die 6. The rivet setting tool 2 comprises a motor 8, connected via a transmission 10 to an actuator 12 (these are all located in respective housings). The rivet setting tool 2 further comprises a blank holder 14 fixed to an end of the actuator 12. The blank holder 14 may also be referred to as a nose. A portion of the blank holder 14 is a hollow cylinder which allows a punch (not depicted) to extend out of the blank holder 14 to insert a self-piercing rivet into the work piece W. The self-piercing rivet may be provided on a tape of self-piercing rivets that feeds into a portion of the rivet setting tool 2. Alternative apparatus may be provided for providing self-piercing rivets. For example, a single rivet feed system may use a pneumatic system to transport a self-piercing rivet from a hopper.

The work piece W may comprise a plurality of panels. The panels may be, for example, aluminium (e.g. cast aluminium or extruded aluminium), steel (e.g. high strength steel) or magnesium. The apparatus (e.g. the rivet insertion tool 2) and methods described herein may be particularly beneficial for use with materials with poor tolerances such as cast aluminium or extruded aluminium. The panels may form part of a car or another vehicle.

The work piece W may optionally further comprise inter-layer substance (e.g. adhesive, sealant and/or foil). For example, a layer of adhesive may be provided between two adjacent panels to provide additionally means of fixing the two adjacent panels together.

The rivet insertion tool 2 may be provided with a blank holder displacement sensor.

The blank holder displacement sensor may also be referred to as means for measuring the displacement of the blank holder 14. For example, the blank holder displacement sensor may be a sensor for measuring the distance travelled by the blank holder 14. The displacement of the blank holder 14 may be measured relative to a point on the rivet insertion tool 2 that is not expected to move while a rivet is being inserted (i.e. a fixed point). The fixed point may be, for example, a point on the actuator 12 or a point of the C-frame 4. The blank holder displacement sensor may be any appropriate sensor for measuring displacement of the blank holder 14. The blank holder displacement sensor may comprise, for example, a contact displacement sensor 20 (as shown in FIG. 1).

The blank holder displacement sensor may comprise a light source and a light sensor, an accelerometer, an inductance sensor, an optical sensor and/or any other sensor known in the art.

In the examples in which the blank holder displacement sensor comprises a contact displacement sensor 20, the contact displacement sensor 20 may comprise a plunger 22 and a sensor body 24. The plunger 22 may be rigid. In an initial position, the plunger 22 may extend out of the sensor body 24 or, alternatively, the plunger 22 may be provided in the sensor body 24 with a surface of an end of the plunger 22 flush with a surface of the sensor body 24. The plunger 22 may be integral with a dust boot of the contact displacement sensor 20. The contact displacement sensor 20 may be provided with a biasing member to return the plunger 22 to the initial position after the plunger 22 has been displaced. The sensor body 24 may comprise one or more sensors to determine the displacement of the plunger 22 from the initial position. For example, the plunger 22 may be pushed inwards (i.e. so more of the plunger 22 is within the sensor body 24 than when in the initial position and/or so the surface of the end of the plunger 22 is within the sensor body 24) and the displacement of the plunger 22 may be measured by the one or more sensors. When the plunger 22 is no longer pushed inwards the biasing member may return the plunger 22 to the initial position. The sensor body 24 of the contact displacement sensor 20 may be fixed relative to the blank holder 14. A face of the plunger 22 that is configured to be in contact with an object being measured by the contact displacement sensor 20 may be referred to as a contact face. The plunger 22 may be axially aligned with the movement of the blank holder 14. Additional components may be provided to fix the sensor body 24 relative to the blank holder 14 such that the sensor body 24 is not directly fixed to the blank holder 14 (but the sensor body 24 and the blank holder 14 are fixed relative to one another). The rivet insertion tool 2 may be provided with a member 30 fixed relative to the fixed point. The member 30 may be rigid with a strike face, for example, the member 30 may be a rod. The member 30 may be rigid. For example, the member 30 may be fixed relative to the actuator 12.

The member 30 may be axially aligned with the movement of the blank holder 14 and placed in contact with an end of the plunger 22 (i.e. the contact face of the contact displacement sensor). In other words, a face of an end of the plunger 22 may be in contact with the strike face of the member 30 thereby allowing the contact displacement sensor 20 to measure the displacement of the member 30.

The contact displacement sensor 20 and the member 30 may allow the position of the blank holder 14 to be measured indirectly. In other words, by measuring a displacement of the contact displacement sensor 20 relative to the member 30, the displacement of the blank holder 14 may be inferred. For example, by measuring a first position of the contact displacement sensor 20 relative to the member 30 when the blank holder 14 is in a first position and a second position of the contact displacement sensor relative 20 to the member 30 when the blank holder 14 is in a second position, the distance between the first and second position of the blank holder 14 may be determined.

While the sensor body 24 has been described as being fixed relative to the blank holder 14 and the member 30 has been described as being fixed to the actuator 12, the rivet insertion tool 2 (and components thereof) may be arranged in any appropriate manner. For example, in an alternative arrangement, the contact displacement sensor 20 may be fixed to the actuator 12 and the member 30 may be fixed relative to the blank holder 14. Other arrangements that enable the position of the blank holder 14 to be measured will be clear to the skilled person.

As mentioned above, the blank holder displacement sensor may comprise an inductance sensor. For example, the plunger 22 may comprise a magnet. The sensor body 24 may comprise a sensing coil and a generation coil. The coils may be arranged coaxially and one within the other. The sensing coil may measure a magnetic field generated by flow of charge through the generation coil. The presence of the magnet within the sensing coil and/or the generation coil may change an impedance and thus the measured magnetic field. Therefore, by measuring the magnetic field, the displacement of the magnet may be measured by the blank holder displacement sensor.

As is also mentioned above, the blank holder displacement sensor may comprise an optical sensor. For example, the plunger 22 may comprise a scale. The sensor body 24 may comprise the optical sensor. The optical sensor may be a CMOS sensor. The blank holder displacement sensor may be configured to determine the displacement of the plunger based on data from the optical sensor. The scale may be linear. Alternatively, the scale may be non-linear. For example, the scale may comprise a complex pattern that allows for more accurate measurement of displacement of the plunger. A portion of the scale may be at least partially translucent. For example, indications of the scale may be provided on a glass portion. A light source may be also provided within the blank holder displacement sensor. For example, when used with an at least partially transparent scale, the light source may be provided on a side of the scale opposed to the optical sensor. In this way, a portion of the scale that is facing the optical sensor may be determined by the contact displacement sensor 20 thereby allowing displacement of the plunger 22 to be measured.

As is also mentioned above, the blank holder displacement sensor may comprise a light source and a light sensor. The light source may be, for example, a laser. The light source may be fixed to the fixed point and the blank holder 14 may be provided with the light source. Alternatively, the light source and the light sensor may be fixed to the fixed point and the blank holder 14 may be provided with a portion for reflecting light. In other words, a part of the blank holder 14 may be provided with one or more reflective surfaces (e.g. a mirror and/or a prism). The light sensor or the reflective surfaces may be provided on a protrusion extending from the blank holder 14. For example, the light sensor or the reflective surfaces may be fixed relative to the blank holder 14 such that the light sensor or the reflective surfaces move with the movement of the blank holder 14. The light source, light sensor and reflective surfaces may be provided in such a way that the light (emitted by the light source) will be detected by the light sensor regardless of the position of the blank holder 14. For example, the light source may emit laser light in a direction parallel to the axis of movement of the blank holder. In the example in which the blank holder 14 is provided with the light sensor, the light sensor may detect the laser light regardless of the position of the blank holder 14. In the example in which the blank holder is provided with reflective surfaces, two reflective surfaces may reflect the laser light such that the laser light travels in a direction parallel to the axis of movement of the blank holder 14 towards the light sensor (regardless of the position of the blank holder 14). By use of, for example, timing measurements (timing a time difference between a pulse of laser light being emitted by the light source and detected by the light sensor) the displacement of the blank holder 14 may be inferred. In examples comprising reflective surfaces, inferring the displacement of the blank holder 14 may require knowledge of the arrangement (e.g. the distance between the two reflective surfaces and/or the speed of light in a prism).

As is also mentioned above, the blank holder displacement sensor may comprise an accelerometer. For example, the accelerometer may measure the acceleration of the blank holder 14 and the measured acceleration may be used to determine the displacement of the blank holder 14.

While a number of example implementations have been provided above, it is to be understood that measuring displacement of the blank holder 14 may be done in any way.

The rivet insertion tool 2 may be provided with a punch displacement sensor. The punch displacement sensor may also be referred to as means for measuring a displacement of the punch. The punch displacement sensor may be, for example, a positional sensor, an accelerometer and/or an encoder. For example, the encoder may allow for measurements of the motor 8 and/or the actuator 12 to determine the displacement of the punch. As an example, the encoder may measure a speed of the motor 8 and/or the actuator 12 as a function of time to allow the displacement of the punch to be determined. As an alternative example, a torque provided by the motor 8 and/or the actuator 12 may be measured and the measured torque may be used to determine the displacement of the punch. As a further example of a punch displacement sensor, a portion of the blank holder 14 may be a cut-out. In other words, a slit may extend axially along the blank holder 14. The punch may be provided with a protrusion that extends out of the cut-out of the blank holder 14. The protrusion may allow for measuring the displacement of the punch through use of a contact displacement sensor (and, optionally, a component e.g. a rod) or a light source and a light sensor in a similar manner as explained above. In other words, a contact displacement sensor (for measuring the displacement of the punch) may contact the protrusion (or a component fixed relative to the protrusion) and may allow measurement of the displacement of the punch relative to a fixed position (i.e. a position of the contact displacement sensor). Alternatively, a light source may be provided at a fixed position and the protrusion may be provided with a light sensor. The light sensor may allow for measurement of the displacement of the punch relative to the fixed position.

The rivet insertion tool 2 may be provided with a force sensor for measuring a force exerted by the punch on a fastener (referred to as a force sensor). The force sensor may also be referred to as means for measuring a force exerted by the punch on a fastener.

The force sensor may be, for example, provided with the punch and may comprise, for example, a load cell and/or a calibrated strain gauge. As an alternative example, the force sensor may comprise an encoder and the encoder may allow positional measurements of the motor 8 and/or the actuator 12 which may be associated with time to determine acceleration of the tool. The positional measurements and a mass of the rivet insertion tool 2 may be used to calculate a force exerted by the punch on a fastener. As an alternative example, a value may be calculated from a model of the rivet insertion tool 2. The model may measure a current applied to the motor to determine a torque of the motor 8, inertia of the actuator 12 and/or deceleration. The model may make calibration corrections to correct for effects caused by, for example, changes in temperature.

While various components of the rivet insertion tool 2 have been described above, it will be appreciated that the rivet insertion tool 2 is merely an example and any appropriate rivet insertion tools may be used. In other words, the methods disclosed herein may be performed with other rivet insertion tools. For example, various delivery systems may be used to deliver fasteners to the rivet insertion tool such as a blow feed system.

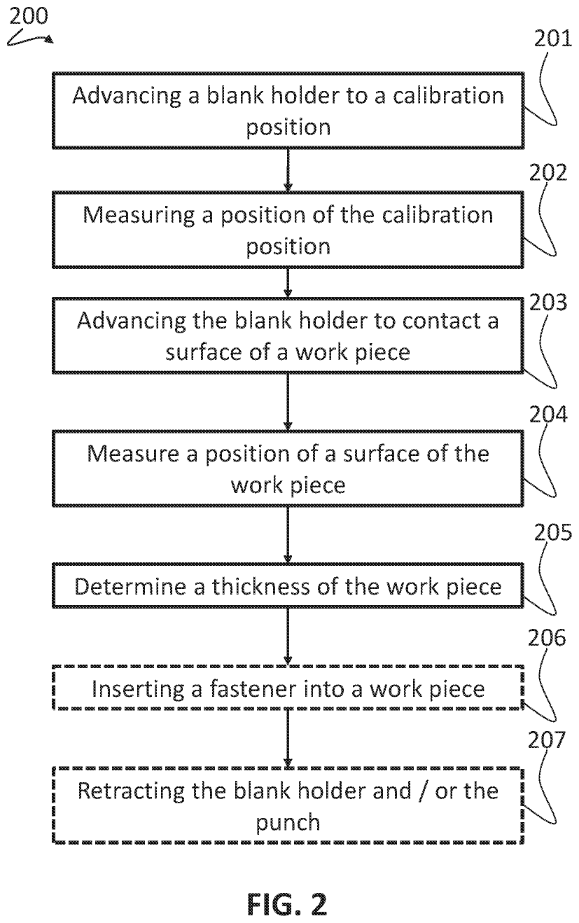

FIG. 2 is a flow diagram depicting a method 200 of determining a thickness of a work piece. At step 201, a blank holder of a fastener setting tool is advanced to a calibration position. At step 202, a position of the calibration position is measured. At step 203, the blank holder is advanced to contact a surface of a work piece. At step 204, a position of a surface of a work piece is measured. At step 205, a thickness of the work piece is determined. At optional step 206, a fastener is inserted the work piece. At optional step 207, the blank holder 314 and/or the punch 312 may be retracted.

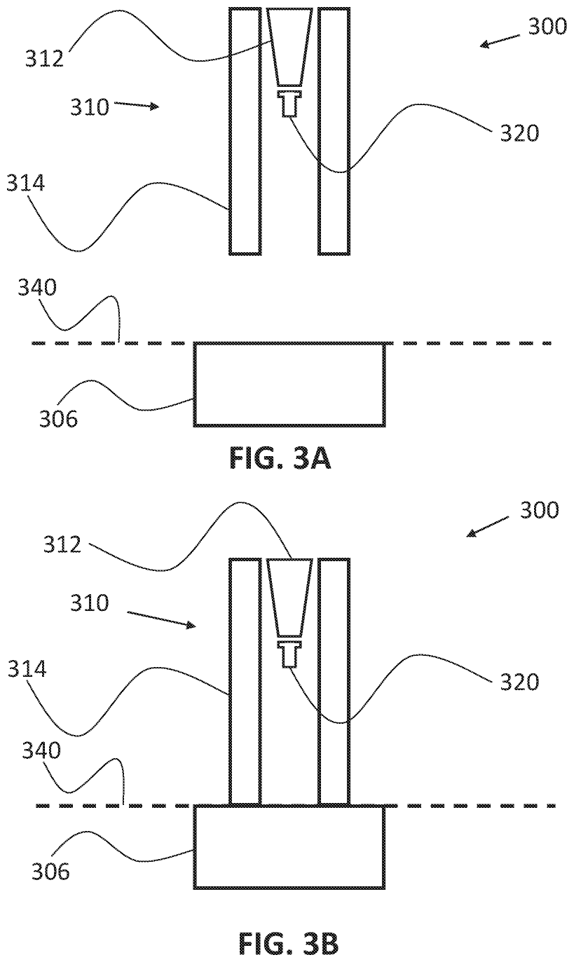

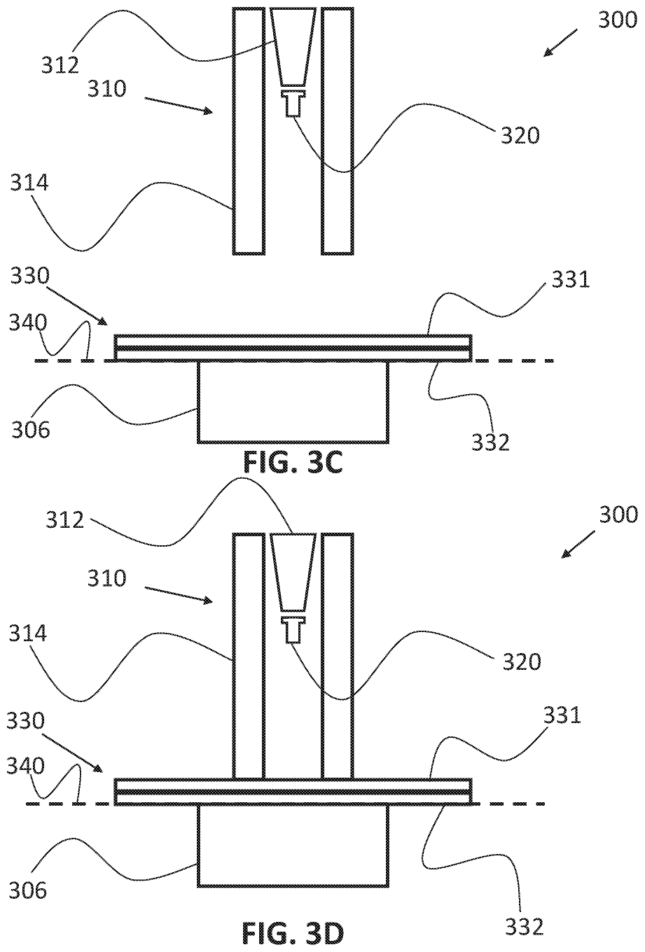

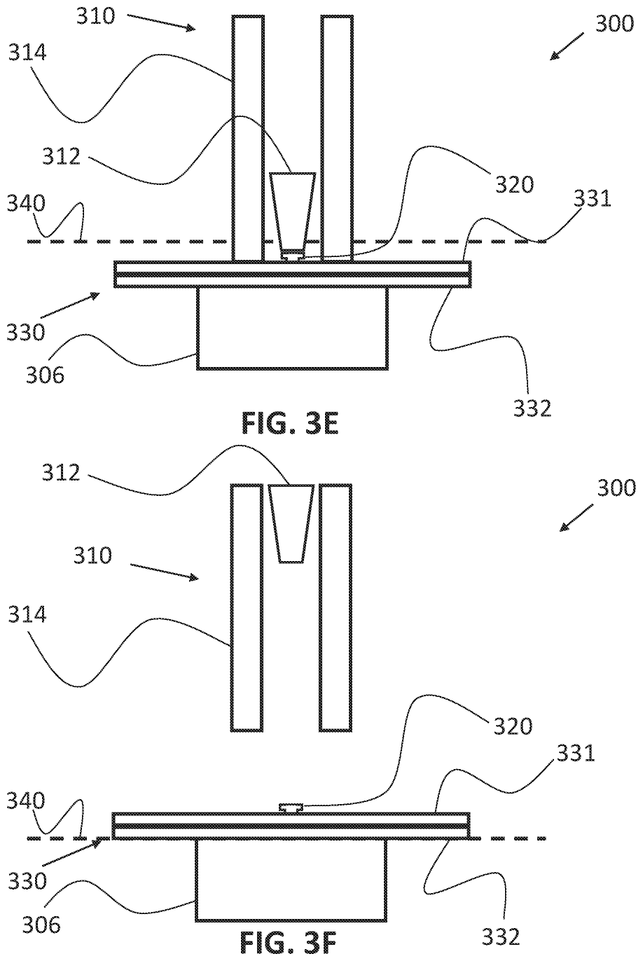

FIGS. 3A-3F (i.e. FIGS. 3A, 3B, 3C, 3D, 3E, and 3F collectively) schematically illustrate a system 300 comprising fastener setting tool 310 during the method 200 of determining a thickness of a work piece. FIGS. 3A-3F will be used to describe the actions caused by the method 200 (and other methods described below e.g. the method 400 and the method 500) in more detail. While different reference numerals are used in FIGS. 3A-3F than in FIG. 1, it is to be understood that the method 200 may be performed on the fastener setting tool 2 shown in FIG. 2.

FIG. 3A depicts a system 300 comprising a fastener setting tool 310. The fastener setting tool 310 comprises a blank holder 314 and a punch 312 (the punch 312 is not shown in FIG. 2). A fastener 320 is held within the blank holder 314 at a position below the punch 312. While the fastener 320 is depicted (in FIG. 3A) as being in a position inside the blank holder 314 and below the punch 312, this is not essential and the fastener 320 may be moved into such a position later. The fastener 320 may be a rivet, for example, a self-piercing rivet. The system 300 further comprises a die 306. An initial position of an upper face of the die 306 is indicated by the datum line 340. The blank holder 314 and the punch 312 are in a retracted position. In other words, there is space between the end of the blank holder 314 configured to contact the work piece and the die 306. The fastener setting tool 310 comprises a blank holder displacement sensor. The blank holder displacement sensor is not depicted and, for example, may be any of the examples described above (i.e. the blank holder displacement sensor may comprise a contact displacement sensor, a light source and a lighter sensor, and/or an accelerometer). The fastener setting tool 310 may further comprise a punch displacement sensor and/or a force sensor (for measuring a force exerted by the punch 312 on the fastener 320).

Referring again to FIG. 2, at step 201 the blank holder 314 is advanced to a calibration position. The calibration position may be a position of the blank holder 314 when the blank holder 314 contacts a surface of a die 306. In other words, the blank holder 314 may touch the surface of the die 306 on which a work piece may be positioned. The blank holder 314 may reach the datum line 340. The blank holder 314 may advance relatively slowly and/or with a relatively low force (i.e. slower or with a smaller force than typical operation of the blank holder 314 as described at step 203) such that neither the blank holder 314 or the die 306 (or any other component) deform due to a force exerted on or by the blank holder 314.

As an alternative, the calibration position may be a position of the blank holder 314 when the blank holder 314 has contacted a surface of a calibration member that has been placed on the die 306. For example, the calibration member may be a nominal work piece (i.e. a work piece that has been determined to have nominal dimensions). In other words, the calibration member may have a thickness the same as an expected thickness of the work piece.

As a further alternative, the calibration position may be a position of the blank holder 314 when the blank holder 314 (or a portion of the blank holder 314) has been aligned with an alignment marker provided on the fastener setting tool 310, for example, on the C-frame. For example, a first visible tab may be provided on the blank holder 314, a second visible tab may be provided on a portion of the C-frame, and the calibration position may be a position of the blank holder 314 when the first and second visible tabs are aligned.

FIG. 3B depicts the system 300 after the blank holder 314 has been advanced to the calibration position (as in step 201). In the example depicted in FIG. 3B, the calibration position is the position of the blank holder 314 when the blank holder 314 has contacted the surface of the die 306. The punch 312 and a fastener 320 remain in a retracted position. While the punch 312 and the fastener 320 are depicted as moving in a manner substantial the same as the blank holder 314 (i.e. the punch 312 and the fastener 320 have not moved relative to the blank holder 314) this may not necessarily be the case. The punch 312 and the fastener 320 may remain in the same position as depicted in FIG. 3A relative to the die 306. In other words, due to the relatively low force applied by the blank holder 314 to the die 306, the upper face of the die 306 remains in the initial position indicated by the datum line 340.

Referring again to FIG. 2, at step 202 a position of the calibration position is measured. In the example in which the calibration position is the position of the blank holder 314 when the blank holder 314 is in contact with the die 306, a position of a surface of a die 306 is measured. In other words, a first position of the surface of the die 306 may be measured. The position of the calibration position may be measured using the blank holder displacement sensor as described above with reference to FIG. 1.

The calibration position may be measured along an axis travelled by the blank holder 314.

In examples in which a contact displacement sensor 20 of the fastener setting tool 310 is fixed relative to the blank holder 314, the displacement of the blank holder 314 may be measured by measuring the displacement of the contact displacement sensor 20. For example, as discussed above, a member 30 may be fixed relative to the fixed point, a contact displacement sensor 20 may be fixed relative to the blank holder 314 and the displacement of the contact displacement sensor 20 relative to the member 30 may be measured to infer the displacement of the blank holder 314. Measuring the position of the calibration position may comprise measuring a first position of the contact displacement sensor 20. In other words, a first position of the contact displacement sensor 20 (relative to the member 30) may be measured while the blank holder 314 is in the calibration position. The position of the calibration position may be expressed as the distance travelled by the blank holder 314 in order for the blank holder to advance to the calibration position and/or contact the surface of the die 306.

While the die 306 is depicted as having a top surface that is substantially flat, in some examples, the die may be shaped to promote flaring of self-piercing rivets. Such dies may not contact work pieces in a uniform manner. There may be regions of the die that are not expected to contact a work piece (when the work piece is first placed on the die). The blank holder 314 may not contact such a die uniformly (i.e. parts of the blank holder 314 that may contact a work piece may not contact the die 306). With such a die, the first position of the surface of the die 306 may be measured at a point of the surface of the die 306 expected to contact a work piece and/or a blank holder 314.

The position of the calibration position may be measured while the fastener setting tool is arranged as depicted in FIG. 3B (as described above). For example, the blank holder displacement sensor may be used to determine the position of the blank holder 314 while the blank holder 314 is in the calibration position.

The method 200 may further comprise retracting the blank holder 314 such that a work piece may be inserted between the blank holder 314 and the die 306. In other words, the blank holder 314 may be retracted by at least the thickness of a work piece. In the examples in which the method comprises use of a calibration member, retracting the blank holder 314 may allow for removal of the calibration member. Retraction of the blank holder 314 may not always be necessary. For example, in the examples in which the calibration position is indicated by first and second visible tabs, a work piece may be placed on the die 396 while the blank holder 314 is in the calibration position.

The method 200 may further comprise placing a work piece 330 in position on the die 306. In other words, the work piece 330 into which a fastener 320 is to be inserted is placed in an appropriate position on the die 306 in the normal manner.

FIG. 3C shows the system 300 comprising a fastener setting tool with the blank holder 314 in a retracted position. A work piece 330 has been placed in position on the die 306. While the work piece 330 is depicted as comprising two panels (a first panel 331 and a second panel 332), work pieces comprising additional panels and other materials (for example, an inter-layer substance such as adhesive) may be used. The weight of the work piece 330 provides a relatively small force (compared to a force applied by the punch 312) and so the upper face of the die 306 remains in substantially the same position as the initial position indicated by the datum line 340.

Referring again to FIG. 2, at step 203 the blank holder 314 is advanced. The blank holder 314 may be advanced such that the blank holder 314 contacts a surface of the work piece 330. In other words, the blank holder contacts an upward facing surface of the upper most panel 331 of the work piece 330. Such operation of a fastener setting tool 310 (such as the retraction of the blank holder 314, the placement of the work piece 330, and the advancement of the blank holder 314) is known in the art and may be carried out in a typical manner. The blank holder 314 may clamp the work piece 330 in a position against the die 306. Alternatively, the blank holder 314 may contact the work piece 330 and provide little or no clamping force.

FIG. 3D shows the system 300 comprising a fastener setting tool with the blank holder 314 in contact with a surface of the work piece 330. In the example of FIG. 3D, the work piece 330 is clamped against the die 306 by the force applied by the blank holder 314. As before, due to the relatively low force applied by the blank holder 314 to the die 306, the upper face of the die 306 remains in the initial position indicated by the datum line 340.

At step 204, a position of a surface of a work piece 330 is measured. The position of the surface of the work piece 330 may be measured along the axis travelled by the blank holder 314. The surface of the work piece 330 (i.e. the work piece that is measured at step 204) may be a surface of the work piece 330 that is opposed to the blank holder 314 and/or the surface of the work piece 330 that is contacted by the blank holder 314.

The position of the surface of the work piece 330 may be measured in a similar manner to measuring the position of the calibration position (as measured at step 202). In other words, the position of the surface of the work piece 330 may be measured by use of the blank holder displacement sensor. For example, measuring the position of the surface of the work piece 330 may comprise measuring a second position of the contact displacement sensor 20 relative to the member 30. As is discussed above, the measured position of the surface of the work piece 330 may be expressed as the distance travelled by the blank holder 314 from the calibration position to a position in which the blank holder 314 contacts the surface of the work piece 330.

The position of the surface of the work piece 330 may be measured while the fastener setting tool 310 is arranged as depicted in FIG. 3D and described above. In other words, the position of the surface of the work piece 330 may be measured while the blank holder 314 is in contact with the surface of the work piece 330. While FIG. 3D depicts the fastener setting tool 310 comprising a fastener 320 in a position ready to be inserted into the work piece 330, a fastener 320 is not required for the fastener setting tool 310 to perform the method 200 of determining a thickness of the work piece 330. At step 205, a thickness of the work piece 330 is determined. Determining the thickness of the work piece 330 may comprise use of the measured position of the calibration position (as measured at step 202) and the measured position of the surface of the work piece 330 (as measured at step 204). In other words, in examples in which the calibration position is the position of the blank holder 314 when the blank holder 314 contacts the surface of the die 306, the difference between the measured position of calibration position and the measured position of the surface of the work piece 330 may correspond to the thickness of the work piece 330. Such a determined thickness may be referred to as an absolute thickness as the determined thickness is not determined with reference to the thickness of another object (i.e. a calibration member).

Alternatively, the determined thickness may be a relative thickness. For example, (as discussed above) the calibration position may be measured through use of a calibration member and/or an alignment marker. In such examples, the determined thickness of the work piece 330 (as determined at step 205) may be relative to a thickness of the calibration member and/or a thickness corresponding to the alignment marker. For example, the work piece 330 may be determined as 1 mm thicker than the thickness of the calibration member.

The method 200 may further comprise receiving the thickness of the calibration member and/or a thickness corresponding to an alignment marker (i.e. a thickness of a calibration member that would extend from the surface of the die 306 to the alignment marker). For example, the thickness of the calibration member may be measured separately and the measured thickness may be provided for use in the method 200. For example, the measured thickness may be stored in a memory and retrieved from storage during the method 200. The method 200 may further comprise determining an absolute thickness from a relative thickness. For example, a calibration member may be 1 mm thick and the work piece 330 may have been determined to have a relative thickness (relative to the calibration member) of 4.6 mm. The work piece 330 may be determined to have an absolute thickness of 5.6 mm thick.

The dimension of the work piece 330 corresponding to the determined thickness may be a dimension parallel to movement of blank holder 14. The thickness of the work piece 330 may be determined while the fastener setting tool 310 is in any arrangement. For example, the thickness of the work piece 330 may be determined immediately after the position of the surface of the work piece 330 is measured (i.e. before a fastener is inserted). Accordingly, the fastener setting tool 310 may be arranged as depicted in FIG. 3D when the thickness of the work piece 330 is determined. Alternatively, the thickness of the work piece 330 may be determined at a later point, for example, after a fastener 320 has been inserted into the work piece 330.

At optional step 206, a fastener 320 may be inserted into the work piece 330. The fastener 320 may be inserted using the punch 312 of the fastener setting tool 310. The fastener 320 may be a self-piercing rivet. In the example in which the fastener 320 is a self-piercing rivet, the punch 312 may apply a force on the self-piercing rivet 320 such that the self-piercing rivet 320 is inserted into the work piece 330 in a region near to, or directly above, the die 306. The self-piercing rivet 320 may flare outwards as the self-piercing rivet 320 is inserted into the work piece 330. In other words, portions of the self-piercing rivet 320 may be forced outwards in a radially outward manner from an axis extending through the self-piercing rivet 320.

FIG. 3E depicts the system 300 comprising a fastener setting tool 310 with the work piece 306 clamped in a position against the die 306 by the blank holder 314. The punch 312 has advanced from an initial position and inserted the fastener 320 into the work piece 330. While FIG. 3E depicts the punch 312 as not protruding from the aperture of the blank holder 314, this is merely exemplary and may not be the case. For example, the punch 312 may (at a position corresponding to a maximum displacement of the punch 312) protrude from the aperture of the blank holder 314 such that the fastener 320 may be inserted into the work piece 330 in a correct manner despite any deformation of the panels 331, 332 of the work piece 330. Due to the relatively high force applied by the punch 312, the system deflects. As a result, the die 306 moves away from the initial position indicated by the datum line 340. While the example of FIG. 3E shows a portion of punch 312 being in line with the datum line 340, the system may deflect more or less than shown.

The fastener 320 may be inserted prior to and/or after the thickness of the work piece 330 being determined. The thickness of the work piece 330 may be determined multiple times (i.e. one or more of the steps 201, 202, 203, 204, and 205 may be carried out multiple times). For example, a position of the surface of the work piece 330 may be measured a first time, the thickness of the work piece 330 may be determined a first time, and the first determined thickness may be used to determine if the work piece 330 is suitable for a fastener 320 to be inserted. A fastener 320 may be inserted. A position of the surface of the work piece 330 may be measured a second time, the thickness of the work piece 330 may be determined a second time, and the second thickness of the work piece 330 may be used to determine a tool deflection (as explained below in more detail in reference to the method 400). Alternatively, the thickness of the work piece 330 may be determined a single time and used to determine if the work piece 330 is suitable for a fastener 320 to be inserted and to determine a tool deflection.

At optional step 207, the blank holder 314 and/or the punch 312 may be retracted. In other words, the blank holder 314 and the punch 312 may be retracted to an initial position ready for the method 200 to begin again with another work piece. The position to which the blank holder 314 is retracted to may be the calibration position.

FIG. 3F depicts the system 300 with the blank holder 314 and the punch 312 retracted. As can be seen in FIG. 3F, the fastener 320 remains inserted in the work piece 330 and the work piece 330 may be removed from the die 306. The blank holder 314 and/or the punch 312 may be retracted at any appropriate time after the fastener 320 has been inserted into the work piece 330. The die 306 may return to the initial position once the punch 312 has stopped applying a force. Alternatively, the method 200 may further comprise resetting the system 300 i.e. returning the die 306 to the initial position. In other words, the die 306 may be moved such that the upper face of the die 306 is in line with the datum line 340.

The determined thickness may be stored. For example, the determined thickness may be stored in computer readable memory. The determined thickness may be stored in a database with other properties relating to the fastener 320, the joint, the work piece 330 and/or the fastener inserting tool 310. For example, an identifier corresponding to the work piece 330, a location of the joint in the work piece 330, and a type of the fastener 320 may also be stored in the database.

The determined thickness may be tested against a pre-determined value in a threshold test. For example, a threshold test may test if the determined thickness of the work piece 330 is at least one of: less than; greater than; less than or equal to; greater than or equal to; and/or equal to one or more predetermined values. The threshold test may be one of a plurality of threshold tests. In other words, a plurality of threshold tests may be applied to the determined thickness and the results may be combined using, for example, Boolean logic. Each threshold test may provide a binary result (i.e. either a 0 or a 1). A result of 1 may indicate the threshold test was passed (i.e. a condition tested in the threshold test was satisfied). The results of the threshold test may be expressed as warning indicators and/or fault indicators. The results of the threshold test may be used to indicate that a particular action is recommended and/or required. The result of the threshold test may be used to cause a particular action to be carried out.

Based on a result of the threshold test applied to the determined thickness, it may be determined that the work piece 330 should be replaced. For example, a threshold test may be used to test if the determined thickness of the work piece 330 falls within a particular range of values. In other words, a nominal thickness may be 6 mm and a corresponding tolerance may be 10% (i.e. the determined thickness may be required to have a value of at least 5.4 mm and less than 6.6 mm). A work piece 330 with a determined thickness of 5.6 mm may satisfy such a threshold test and the work piece 330 may be used in a normal manner. A work piece 330 with a determined thickness of 7 mm may fail (i.e. not satisfy) such a threshold test. In the event of such a threshold test being failed, the work piece 330 may be identified as not suitable for use in a process and/or product. An indication may be provided to indicate that the work piece 330 should be replaced. Additionally or alternatively, the work piece 330 may be replaced. In other words, the work piece 330 may be removed from the process (and not used to construct the product being made) and a different work piece 330 may be used.

Based on a result of the threshold test applied to the determined thickness, it may be determined that the fastener setting tool 310 requires maintenance. If such a threshold test is satisfied, the fastener setting tool 310 may be determined to be within normal operating conditions. Alternatively, if such a threshold test is failed, it may be determined that the fastener setting tool 310 requires maintenance. An indication may be provided to indicate that the fastener setting tool 310 requires maintenance and/or what maintenance in particular is needed. Additionally or alternatively, the maintenance may be carried out. In other words, the fastener setting tool 310 may carry out the required maintenance on itself or cause the required maintenance to be carried out.

Based on a result of the threshold test applied to the determined thickness, it may be determined that a parameter associated with the fastener setting tool 310 should be adjusted. For example, a threshold test may be used to test if the determined thickness of a work piece 330 is less than a value, for example, 5.4 mm. If such a threshold test is satisfied, the fastener setting tool 310 may, for example, decrease a force used to insert the fastener 320 into the work piece 330. As another example, a threshold test may be used to test if the determined thickness of a work piece 330 is greater than a value, for example, 6.6 mm. If such a threshold test is satisfied, the fastener setting tool 310 may, for example, increase a force used to insert the fastener 320 into the work piece 330. If either of the example threshold tests describe here are failed (i.e. the determined thickness of the work piece 330 is greater than or equal to 4 mm and less than or equal to 5 mm), the determined thickness of the work piece 330 may be determined to be acceptable and no adjustment may be made to the parameter associated with the fastener setting tool 310. Other example parameters that may be adjusted comprise, for example, the type of the fastener being inserted (i.e. a first type of rivet may be changed for a second type of rivet), the type of the die on the fastener setting tool 310, an amount of adhesive provided between panels 331, 332 of the work piece 330, an end position of the punch 312 and/or a clamping force applied by the blank holder 314. The parameters may be changed for, or in relation to, the work piece 330 for which the thickness has been determined. In other words, an increased force may be used to insert a fastener 310 into the measured work piece 330. Additionally or alternatively, the parameters may be changed for subsequent work-pieces. In otherwords, an increased force may be used to insert fasteners into work pieces that are subsequent to the measured work piece 330.

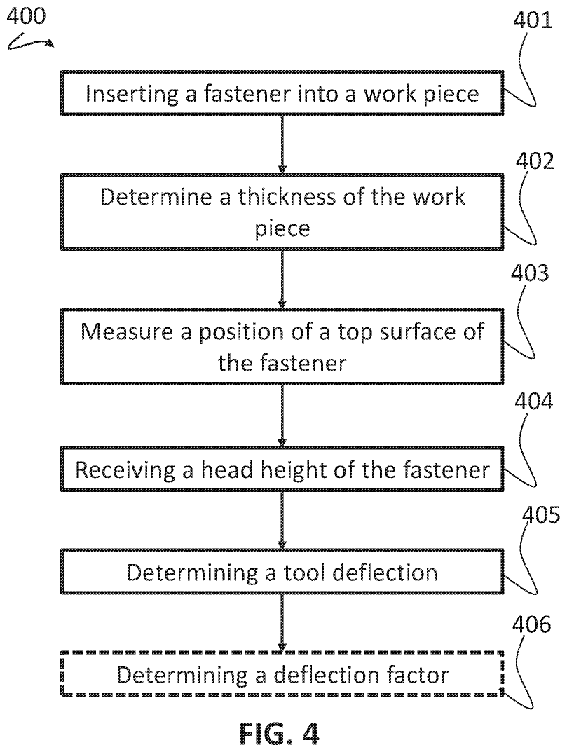

FIG. 4 depicts a flow diagram of a method 400 for determining a tool deflection. At step 401, a fastener 320 is inserted into a work piece 330. At step 402, a thickness of the work piece 330 is determined. At step 403, a position of a top surface of the fastener 320 is measured. At step 404, a head height of the fastener 320 is received. At step 405, a tool deflection is determined. At optional step 406, a deflection factor may be determined.

At step 401, the fastener 320 is inserted into the work piece 330. The fastener 320 may be inserted into the work piece 330 as described above in relation to the method 200. In examples of the method 400 in which the deflection factor is determined, inserting the fastener into the work piece 330 may further comprise determining a peak force exerted by the punch 312 on the fastener 320.

The peak force exerted by the punch 312 on the fastener 320 may be measured using the force sensor. The force may be measured continuously (or discretely with a high sampling rate) as a function of time and the maximum recorded force may be determined. Alternatively, the force may be measured at one or more time points. The one or more time points may be determined (i.e. triggered) by other measurements. For example, the positional measurements of the motor 8 (discussed above in relation to the force sensor) may allow the displacement of the punch 312 may be measured. The measured displacement of the punch 312 may be used to determine a speed of travel for the punch 312 and the determined speed may be used to determine a time point for when a force should be measured (by the force sensor) or calculated (from a model of the rivet insertion tool 2). For example, the speed of the punch 312 may be determined and calculation of the force exerted by the punch 312 on the fastener 320 may be triggered when the speed of the punch 312 drops below a value, for example 4 mm/s. At step 402, the thickness of the work piece 330 is determined. The thickness of the work piece 330 may be determined as described above in relation to the method 200 and, in particular, step 205.

At step 403, the position of the top surface of the fastener 320 is measured. The top surface of the fastener 320 may be a surface of the fastener 320 opposed to and/or contacted by the punch 312. In other words, the position of the surface of the fastener 320 opposed to the punch 312 may be measured. The top surface of the fastener 320 may be a surface of the fastener 320 closest to the blank holder 314 when the blank holder 314 is in a retracted position (i.e. as depicted in FIG. 3A).

The position of the top surface of the fastener 320 may be measured relative to the measured position of the surface of the die 306 (as measured at step 202). The position of the top surface of the fastener 320 may be measured relative to the calibration position. The position of the top surface of the fastener 320 may be measured using the punch displacement sensor. As displacement of the punch 312 positions the fastener 320, the maximum displacement of the punch 312 may correspond with the position of the top surface of the fastener 320. Therefore, the maximum displacement of the punch 312 may be assumed to correspond to the position of the top surface of the fastener 329.

Alternatively, the position of the top surface of the fastener 320 may be measured using the blank holder displacement sensor. For example, the blank holder 314 may be retracted and the position of the work piece 330 (and the fastener 320) may be moved such that when the blank holder 314 is advanced, the blank holder 314 contacts the top surface of the fastener 320.

At step 404, the head height of the fastener 320 may be received and/or measured.

The measured head height of the fastener 320 may be measured manually, for example, by an operator with a (dial test indicator) DTI gauge and the measured head height may be provided as an input to the fastener setting tool 310, e.g. via a human-machine interface. Alternatively other measurement apparatus may be used, for example, measuring apparatus that use optical effects to measure the head height of the fastener 320.

At step 405, the tool deflection may be determined. The tool deflection may correspond to changes in end positions relative to starting positions of components of the fastener setting tool 310 due to insertion of the fastener. In other words, components of the fastener setting tool 310 may move due to forces applied to the fastener 320 during insertion of the fastener 320. The end positions may be positions of components prior to retraction of the punch 312 and the blank holder 314. In other words, the end positions may correspond to the positions of components as depicted in FIG. 3E (for simplicity, movement due to tool deflection is not depicted in any of FIGS. 3A-3F). Examples of components which may move due to deflection comprise the C-frame, the die 306, and/or one or more linkages within the fastener setting tool 310. As the distance between an end position of the end of the punch 320 and an end position of the die 306 is generally equivalent to the sum of the thickness of the work piece 330 and the head height of the fastener 320, a measurement (or determination) of each of: the end position of the punch 320; the thickness of the work piece 330 and the head height of the fastener 320 may be used to determine the tool deflection.

By use of a measured head height of a fastener 320, a measured thickness of a work piece 330, and a measured position of the top surface of the fastener 320, the tool deflection may be determined. In otherwords, the tool deflection, TD, may be determined as:

$$TD = HH + MT - ED$$

where: HH is the measured head height of the fastener 320; MT is the determined thickness of the work piece 330; and ED is the determined position of the top surface of the fastener 320.

As mentioned above, the thickness of the work piece 330 may be determined after the fastener 320 is inserted into the work piece 330. Beneficially, by carrying out the steps of the method 400 in this order, the effect of any changes in the thickness of the work piece 330 due to the insertion of the fastener 320 on the determined tool deflection will be minimized. Minimizing may include entirely removing any effect of any changes in the thickness of the work piece 330 due to insertion of the fastener 320 on the tool deflection. Alternatively, the thickness of the work piece 330 may be determined before the fastener 320 is inserted into the work piece 330. Beneficially, by carrying out the method steps in this order, duplication of measurements may be reduced and the method 400 may be carried out quicker than otherwise.

The tool deflection may be used to compare the deflection of the fastener setting tool 310 when inserting different fasteners and/or determine a property of the fastener 320, the joint, the work piece 330 and/or the fastener setting tool 310. For example, the tool deflection may be used to determine a deflection factor and the deflection factor may be used to determine a head height of a fastener 320 (as explained below). As a further example, the tool deflection may indicate wear on components of the fastener setting tool 310 and changes in tool deflection (for similar fasteners and work pieces) across a period of time may indicate that maintenance and/replacement is required for one or more of the components of the fastener setting tool 310.

The method 400 may further comprise determining a deflection factor corresponding to a deflection of the fastener setting tool 310 to the peak force exerted by the punch 312 on the fastener 320. The deflection factor, DF, may be determined as:

$$DF = TD \div PF$$

where PF is the determined peak force. The tool deflection may be used in the determination of the deflection factor either explicitly, or alternatively, implicitly. In other words, the deflection factor may also be determined as:

$$DF = ( HH + MT - ED ) \div PF$$

For example, for a measured head height of 0.02 mm, a determined thickness of 5.63 mm, a measured position of the punch of 3.25 mm, and a measured peak force of 57.40 kN, the tool deflection may be determined as 2.40 mm and the deflection factor may be determined as 0.042 mm/kN.

The tool deflection and/or the deflection factor may be determined at regular intervals or in response to particular events. For example, the tool deflection and/or the deflection factor may be determined after a set number of fasteners have been inserted, for example after every 250,000 or 500,000 fasteners have been inserted. The tool deflection and/or the deflection factor may be determined after maintenance work has been carried out on the fastener setting tool 310 and/or the die 306. The tool deflection and/or the deflection factor may be determined when a different batch of components is used, for example, when a different batch of fasteners 320 is used and/or the work piece 330 comprises a different batch of panels 331, 332.

The tool deflection and/or the deflection factor may be stored. For example, the tool deflection and/or the deflection factor may be stored in computer readable memory. The tool deflection and/or the deflection factor may be stored in a database with other properties relating to the fastener 320, the joint, the work piece 330 and/or the fastener inserting tool 310. For example, an identifier corresponding to the work piece 330, a location of the joint in the work piece 330, and a type of the fastener 320 may also be stored in the database. Other properties may include, for example, the type of the die 306 and/or the type of an adhesive.

The tool deflection and/or the deflection factor may be tested against a pre-determined value in a threshold test in a similar manner to as described above in relation to the determined thickness of the work piece 330. The results of the threshold test may be expressed as warning indicators and/or fault indicators. The results of the threshold test may be used to indicate that a particular action is recommended and/or required. The result of the threshold test may be used to cause a particular action to be carried out.

Based on a result of the threshold test applied to the tool deflection and/or the deflection factor, it may be determined that the work piece 330 should be replaced. For example, a threshold test may be used to test if the tool deflection and/or the deflection factor falls within a particular range of values. In the event of such a threshold test being failed, a component (e.g. the work piece 330, the fastener setting tool 310 or a portion of either the work piece 330 or the fastener setting tool 310) may be identified as not suitable for use in a process and/or product. An indication may be provided to indicate that the component should be replaced. Additionally or alternatively, the component may be replaced. In other words, the component may be removed from the process (and not used to construct the product being made) and a different component may be used. As an example, the C-frame 4 may be a component which may be identified as not suitable for use in the process.

Based on a result of the threshold test applied to the tool deflection and/or the deflection factor, it may be determined that the fastener setting tool 310 requires maintenance. For example, a threshold test may be used to test if the determined tool deflection is lower than a threshold tool deflection value, for example, 2 mm. If such a threshold test is satisfied, the fastener setting tool 310 may be determined to be within normal operating conditions. Alternatively, if such a threshold test is failed, it may be determined that the fastener setting tool 310 requires maintenance. An indication may be provided to indicate that the fastener setting tool 310 requires maintenance and/or what maintenance in particular is needed. Additionally or alternatively, the maintenance may be carried out. In other words, the fastener setting tool 310 may carry out the required maintenance on itself or cause the required maintenance to be carried out.

Based on a result of the threshold test applied to the tool deflection and/or the deflection factor, it may be determined that a parameter associated with the fastener setting tool 310 should be adjusted. For example, a threshold test may be used to test if the tool deflection is greater than a value, for example, 3 mm. If such a threshold test is satisfied, the fastener setting tool 310 may, for example, increase a force used to insert the fastener 320 into the work piece 330. As another example, a threshold test may be used to test if the tool deflection is less than a value, for example, 2 mm. If such a threshold test is satisfied, the fastener setting tool 310 may, for example, decrease a force used to insert the fastener 320 into the work piece 330. If either of the example threshold tests describe here are failed, the tool deflection and/or the deflection factor may be determined to be acceptable and no adjustment may be made to the parameter associated with the fastener setting tool 310. Other example parameters that may be adjusted comprise, for example, the type of the fastener being inserted (i.e. a first type of rivet may be changed for a second type of rivet), an amount of adhesive provided between panels 331, 332 of the work piece 330, an end position of the punch 312 and/or a clamping force applied by the blank holder 314.

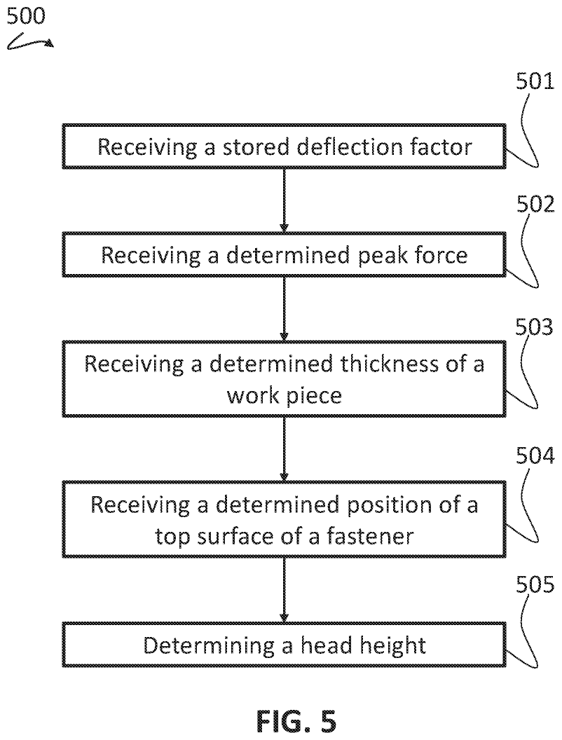

FIG. 5 depicts a method 500 of determining a property of a fastener 320. At step 501, a stored deflection factor is received. At step 502, a determined peak force is received. At step 503, a determined thickness of a work piece is received. At step 504, a determined position of a top surface of a fastener is received 504. At step 505, a head height is determined.

FIGS. 3A-3F will again be referred to describe the method 500.

The method 500 may be used to determine a property of a fastener 320 that has already been inserted into a work piece 330. For example, a peak force (used to insert the fastener 320 into the work piece 330) may be determined during the insertion of the fastener 320 and the determined peak force may be used in the method 500 (at step 505). Alternatively, the method 500 may comprise inserting the fastener 320 and measuring the peak force during the insertion of the fastener 320. As a further alternative, the fastener 320 may be inserted with a predetermined peak force and the predetermined peak force may be used in the method 500. The fastener 320 may be inserted with a predetermined torque applied used by the fastener setting tool 310.

At step 501, a stored deflection factor is received. The stored deflection factor may have previously been determined as in the method 400 (and described above). The stored deflection factor may be related to/associated with a location (or planned location) of the fastener 320 in the work piece 330 and/or similar work pieces. In other words, if the fastener 320 was (or was to be) inserted in a different location in the work piece 330 a different deflection factor may be received. If the fastener 320 was (or was to be) inserted in a similar location in a similar work piece 330, the same deflection factor may be received. Alternatively, the deflection factor may be consistent across a work piece 330 and/or similar work pieces.

The method 500 may further comprise receiving and/or determining one or more properties of the fastener 320, a joint (i.e. the joint made by fastener 320) and/or the work piece 330 (i.e. the work piece 330 in which the fastener 320 has been, or will be, inserted). For example, the location of the joint in the work piece 330 may be determined and used to determine which stored deflection factor is received from a database (the database storing a plurality of deflection factors, each deflection factor having a corresponding location).

The deflection factor for a system 300 (comprising a fastener setting tool 310, work piece 330 and fastener 320) may be constant (or approximately constant) for all systems comprising the same and/or similar type of fastener setting tools 310, work pieces 330 and fasteners 320. In other words, the deflection factor may allow the head height of a fastener 320 to be inferred without directly measuring the head height of the fastener 320.

At step 502, a determined peak force is received. The determined peak force may correspond to the peak force exerted by a punch 312 of the fastener setting tool 310 on the fastener 320. The determined peak force may be determined in the same manner as described above.

At step 503, a determined thickness of a work piece 330 is received. The thickness of the work piece 330 may be determined in the same manner as described above in the method 200 and/or at the step 402.

At step 504, a determined position of a top surface of a fastener 320 is received. The position of the top surface of the fastener 320 may be determined in the same manner as described above at step 403.

At step 505, a head height of the fastener 320 is determined. The head height, HH, of the fastener 320 may be determined as:

$$HH = ( DF \times PF ) - MT + ED$$

where: DF is the stored deflection factor; PF is the measured peak force; MT is the determined thickness of the work piece 330; and ED is the measured position of the top surface of the fastener 320. For example, for a stored deflection factor of 0.042 mm/kN, a measured peak force of 57.4 kN, and determined thickness of the work piece 330 of 5.63 mm, and a measured position of the top surface of the fastener 320 of 3.25 mm, the head height may be determined as 0.02 mm. Accordingly, the head height of a fastener 320 may be determined by using other measured values avoiding the need to directly measure the head height itself.

The head height of the fastener 320 may be indicative of a property of the work piece 330 and/or a joint made in the work piece 330. For example, the head height may indicate a strength of the joint. The head height may also be referred to as the position of a top surface of a head of the fastener 320 relative to a top surface of the work piece 330 in a region close to the fastener 320. The region close to the fastener 320 may be immediately surrounding the fastener 320 or may be a region beyond a region that has been deformed due to the fastener 320 being inserted. The determined head height of the fastener 320 may provide an indication of the strength (or another property) of the joint as an alternative to (or in addition to) destructive testing. For example, a head height of a first fastener 320 in a first work piece 330 may be determined and a strength of a corresponding first joint may be determined using destructive testing. A head height of a second fastener 320 in a second work piece 330 may be determined and used to infer the strength of a corresponding second joint based on the head height and strength of the first joint.

The determined head height may be stored. For example, the determined head height may be stored in computer readable memory. The determined head height may be stored in a database with other properties relating to the fastener 320, the joint, the work piece 330 and/or the fastener inserting tool 310. For example, an identifier corresponding to the work piece 330, a location of the joint in the work piece 330 and a type of the fastener 320 may also be stored in the database.

The determined head height may be tested against a pre-determined value in a threshold test in a similar manner to as described above in relation to the determined thickness of the work piece 330. The results of the threshold test may be expressed as warning indicators and/or fault indicators. The results of the threshold test may be used to indicate that a particular action is recommended and/or required. The result of the threshold test may be used to cause a particular action to be carried out.

Based on a result of the threshold test applied to the determined head height, it may be determined that the work piece 330 should be replaced. For example, a threshold test may be used to test if the determined head height falls within a particular range of values. In other words, a nominal head height may be 0.02 mm and a corresponding tolerance may be 10%. The determined head height may be required to have a head height of at least 0.018 mm and less than 0.022 mm. A work piece 330 with a determined head height of 0.019 mm may satisfy such a threshold test and used in a normal manner. A fastener 320 with a determined head height of 0.023 mm may fail (i.e. not satisfy) such a threshold test. In the event of such a threshold test being failed, the work piece 330 and/or the fastener 320 may be identified as not suitable for use in a process and/or product. An indication may be provided to indicate that the work piece 330 and/or the fastener 320 should be replaced. Additionally or alternatively, the work piece 330 and/or the fastener 320 may be replaced. In other words, the work piece 330 and/or the fastener 320 may be removed from the process (and not used to construct the product being made) and a different work piece 330 and/or fastener 320 may be used.

Based on a result of the threshold test applied to the determined head height, it may be determined that the fastener setting tool 310 requires maintenance. For example, a threshold test may be used to test if the determined head height is higher and/or lower than a threshold head height value, for example, 0.025 mm. If such a threshold test is satisfied, the fastener setting tool 310 may be determined to be within normal operating conditions. Alternatively, if such a threshold test is failed, it may be determined that the fastener setting tool 310 requires maintenance. An indication may be provided to indicate that the fastener setting tool 310 requires maintenance and/or what maintenance in particular is needed. Additionally or alternatively, the maintenance may be carried out. In other words, the fastener setting tool 310 may carry out the required maintenance on itself or cause the required maintenance to be carried out.

Based on a result of the threshold test applied to the determined head height, it may be determined that a parameter associated with the fastener setting tool 310 should be adjusted. For example, a threshold test may be used to test if the determined head height of a fastener 320 is less than a value, for example, 0.025 mm. If such a threshold test is satisfied, the fastener setting tool 310 may, for example, decrease a force used to insert the fastener 320 into the work piece 330. As another example, a threshold test may be used to test if the determined head height of a fastener 320 is greater than a value, for example, 0.03 mm. If such a threshold test is satisfied, the fastener setting tool 310 may, for example, increase a force used to insert the fastener 320 into the work piece 330. If either of the example threshold tests describe here are failed, the determined head height of the fastener 320 may be determined to be acceptable and no adjustment may be made to the parameter associated with the fastener setting tool 310. Other example parameters that may be adjusted comprise, for example, the type of the fastener 320 being inserted (i.e. a first type of rivet may be changed for a second type of rivet), the type of die 306, an amount of adhesive provided between panels 331, 332 of the work piece 330, an end position of the punch 312 and/or a clamping force applied by the blank holder 314.

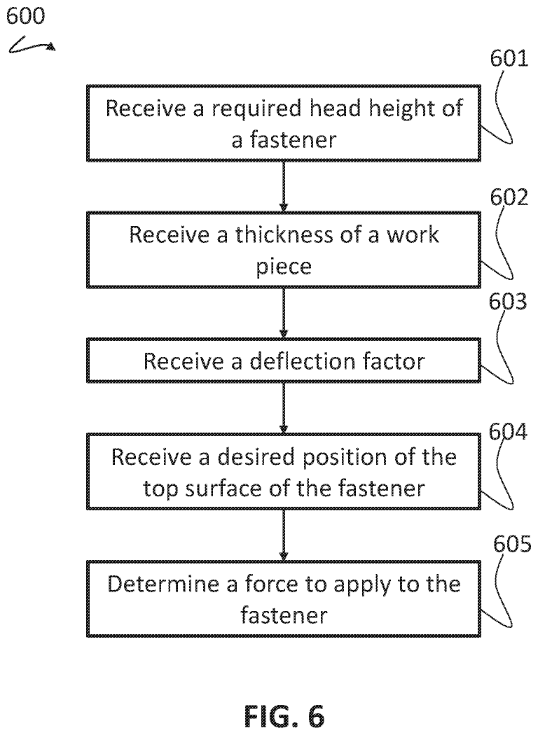

FIG. 6 is a flow diagram depicting a method 600 of determining a force for inserting a fastener 320. At step 601, a required head height of a fastener 320 is received. At step 602, a thickness of a work piece 330 is received. At step 603, a deflection factor is received. At step 604, a desired position of the top surface of the fastener 320 is received. At step 605, a force to apply to the fastener 320 is determined.

At step 601, a required head height of a fastener 320 is received. The required head height may be determined based on one or more properties of the work piece 330 and/or the joint in the work piece 330. For example, it is known that the head height of a fastener 320 corresponds to a strength of a joint made by the fastener 320 in the work piece 330. The joint may be required to have a minimum strength and the minimum strength may be used to determine a required head height of a fastener 320. Additionally or alternatively, the work piece 330 (once assembled into a product) may be expected to move relative to another part of the product and the expected movement may be used to determine a required head height of a fastener 320. For example, the work piece 330 may be a doorframe of a car and a corresponding door may be expected to move relative to the door frame. Such movement may provide a maximum head height of a fastener 320 inserted into the work piece 330. In other words, if the fastener 320 has a head height above the maximum, the door 320 may foul the door frame and prevent requirement movement of the door (e.g. the door may not be able to opened and/or closed).

At step 602, a thickness of a work piece 330 is received. The received thickness of the work piece 330 may have been determined as in the method 200 described above. Additionally or alternatively, the thickness of the work piece 330 may be have been determined using any methods or apparatus known in the art. For example, a set of callipers may be used. Additionally or alternatively, the thickness of the work piece 330 may be the thickness of a nominal work piece.

At step 603, a deflection factor is received. The received deflection factor may be determined as in the method 200 described above. The deflection factor may be received in a similar to manner as receiving the stored deflection factor (at step 501). The deflection factor may correspond to a location of the joint in the work piece 330, one or more properties of the work piece 330 (for example, a hardness of the panels 331, 332 in the work piece 330), one or more properties of the fastener setting tool 310 (for example, a stiffness of the C-frame 4) and/or one or more properties of the fastener 320 (for example, a hardness or an flaring of the fastener 320).

At step 604, a desired position of the top surface of the fastener 320 is received. The desired position of the top surface of the fastener 320 may have been determined based on one or more properties of the work piece 330 and/or the fastener 320. Additionally or alternatively, fasteners inserted into work pieces previously may be used to determine a desired position of the top surface of the fastener 320.

At step 605, a force to apply to the fastener 320 is determined. In other words, after using the determined force to insert the fastener 320 into the work piece 330, the head height of the fastener 320 may be equal to (or approximately equal to) the required head height. The force, PF, may be determined as:

$$PF = \frac{HH + MT - ED}{DF}$$

where HH is the required head height of the fastener, DF is the deflection factor, MT is the thickness of the work piece, and ED is the position of the top surface of the fastener.

The method 600 may further comprise inserting the fastener 320 into the work piece 330 with a punch 312 of a fastener setting tool 310. The determined force (i.e. the force determined at step 605) may be applied to the fastener 320 using the punch 312.

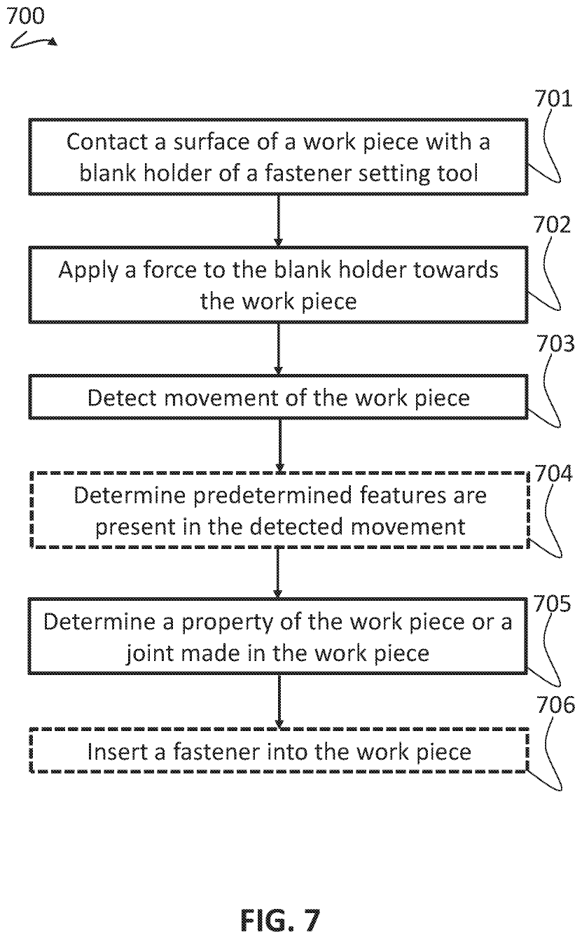

FIG. 7 is a flow diagram depicting a method 700 of determining a property of a work piece 330 or a joint (i.e. a joint made by a fastener 320) made in a work piece 330. At step 701, a blank holder of a fastener setting tool 310 contacts a surface of the work piece 330. At step 702, a force is applied to the blank holder 314. At step 703, movement of the work piece 330 is detected. At optional step 704, predetermined features may be determined as present in the detected movement. At step 705, the property of the work piece 330 or joint made in the work piece 330 is determined. At optional step 706, a fastener 320 may be inserted into the work piece 330.

At step 701, a blank holder 314 of a fastener setting tool 310 contacts a surface of the work piece 330. In other words, the blank holder 314 may contact the surface of the work piece 330 as depicted in FIG. 3D. The blank holder 314 may move to contact the surface of the work piece 330 with a low speed and/or low force such that the time point when the blank holder 314 contacts the surface of the work piece 330 may be identified and/or measured. For example, after contacting the surface of the work piece 330 the speed of, or force applied to, the blank holder 314 may be changed.

At step 702, a force is applied to the blank holder 314. The force may be applied 314 in a direction axial to the blank holder 314 towards the work piece 330. In other words, the blank holder 314 may have an axis along which (or parallel to which) the blank holder 314 may be moved. The force may be applied 314 along the axis towards the work piece 330. The force may be a consistent force i.e. the force may have a constant magnitude and/or direction during the time during which the force is applied. The force may be applied continuously while the movement of the work piece 330 is detected. In other words, steps 702 and 703 may be carried out simultaneously. Alternatively, movement of the work piece 330 may be detected after the force has stopped being applied.

The magnitude of the applied force may be selected such that the applied force may cause some movement and the movement may be detected. For example, the applied force may be sufficient to close panel gaps (i.e. regions of void space between neighbouring panels 331, 332 of the work piece 330) over a time period which may be measured. As another example, the applied force may have a magnitude large enough to cause measurable oscillations in the work piece 330 but small enough to not critically damp or overdamp the oscillations. In other words, if the applied force is too large the applied force will prevent the panels 331, 332 from oscillating.

At step 703, movement of the work piece 330 is detected. The movement may be caused by the force applied to the blank holder 314. The movement may be detected by measuring displacement of the blank holder 314. In other words, while the blank holder 314 is in contact with the work piece 330 and while a force is applied to the blank holder 314 in the direction of the work piece 330, movement of the work piece 330 will cause movement of the blank holder 314. The movement may be in line with the axis of the blank holder 314. The movement of the blank holder 314 may change the displacement of the blank holder 314. Changes in the displacement of the blank holder 314 may be measured by the blank holder displacement sensor. For example, in examples in which the work piece 330 oscillates, the blank holder 314 may also oscillate and the movement of the blank holder 314 may be detected by the blank holder displacement sensor.

At optional step 704, predetermined features may be determined as present in the detected movement. In other words, the predetermined features may be identified in the detected movement. For example, the predetermined features may comprise consistent movement in a single direction. As an alternative, the predetermined features may comprise oscillations.

At step 705, the property of the work piece 330 or joint made in the work piece 330 is determined. The property may be determined based on the detected movement (i.e. the movement detected at step 703) and/or the determination that predetermined features are present in the detected movement. The property may be, for example, presence of panel gaps, a size of panel gaps, presence of adhesive and/or an amount of adhesive present. Additionally or alternatively, the property may be a stiffness, a ductility, and/or a strength (e.g. an ultimate tensile strength) of one or more panels 331, 332 in the work piece 330.

At optional step 706, a fastener 320 may be inserted into the work piece 330. For example, the fastener 320 may be inserted using a punch 312 of a fastener setting tool 310. The force may be applied to the blank holder 314 prior to, during, and/or after the insertion of the fastener 320. In examples in which the method 700 comprises inserting a fastener 320 into the work piece 330, the movement of the work piece 330 may comprise movement in response to the fastener 320 being inserted (by the punch 312 of the fastener setting tool 310) into work piece 330. In examples in which the method 700 comprises inserting a fastener 320 into the work piece 330, the property may be a distortion and/or deflection of the work piece 330 (or panels 331, 332 of the work piece 330). Distortion may correspond to under-head gaps, underfill and/or overfill in a region near to the fastener 320.

As a first example of the method 700, a work piece 330 may comprise two panels 331, 332 with a panel gap between the two panels 331, 332. The blank holder 314 may contact a surface of the work piece 330 and the blank holder 314 may apply a force to the blank holder 314 towards the work piece 330. Under the applied force, the panels 331, 332 of the work piece 330 may be squeezed together reducing or closing the panel gap. In other words, the panels 331, 332 may gradually move together causing similar gradual movement of the blank holder 314. The gradual movement of the blank holder 314 may be detected by the blank holder displacement sensor and the detected movement may be used to identify the presence of panel gaps. The force may be applied until the panels 331, 332 stop moving e.g. due to the panel gap being closed. The detected movement may also be used to determine the size of the panel gap that was present prior to the force being applied.

As a second example of the method 700, a work piece 330 may comprise two panels 331, 332 with adhesive between the two panels 331, 332. The blank holder 314 may contact a surface of the work piece 330 and the blank holder 314 may apply a force to the blank holder 314 towards the work piece 330. Under the applied force, the panels 331, 332 of the work piece 330 may be squeezed together reducing the amount of adhesive between opposing points on the two panels 331, 332. In other words, the panels 331, 332 may gradually move together causing similar gradual movement of the blank holder 314. The adhesive may be squeezed within the space between the two panels 331, 332 i.e. spreading the adhesive in a more uniform manner. Additionally or alternatively, the adhesive may be squeezed out of the space between the two panels 331, 332. The gradual movement of the blank holder 314 may be detected by the blank holder displacement sensor and the detected movement may be used to determine the presence of adhesive.

As a third example of the method 700, panels 331, 332 of a work piece 330 may be in a first position. After insertion of a fastener 320 into a work piece 330, the panels 331, 332 of the work piece 330 may have moved to a second position. In other words, part of an upper most panel 331 may move downwards causing the blank holder 314 to move downwards by a corresponding amount. The downwards movement of the blank holder 314 may be detected by the blank holder displacement sensor. The detected movement may be used to determine that a material within the work piece 330 was distorted during insertion of the fastener 320.

As a fourth example of the method 700, a fastener 320 may be inserted into a work piece 330. While the fastener 320 is being inserted, portions of the work piece 330 may be deflected upward. For example, a first portion of the work piece 330 (i.e. near to where the fastener 320 is being inserted) may be pushed downwards from a first position into a die 306 with concave portions. The shape of the die 306 (in particular, the concave portions) may deflect a second portion of the work piece 330 (i.e. further away from where the fastener 320 is being inserted) upwards from a corresponding first position. Once the fastener 320 has been inserted into the work piece 330 (and the punch 312 is retracted) the first portion of the work piece 330 may no longer be pushed downwards into the die 306. The first portion of the work piece 330 may return to the first position and the second portion of the work piece 330 may return to the corresponding first position. Such movement of the first or second portion of the work piece 330 may cause corresponding movement of the blank holder 314 and may be detected by the blank holder displacement sensor. The detected movement may be used to determine a brittleness and/or hardness of the panels 331, 332 of the work piece 330.

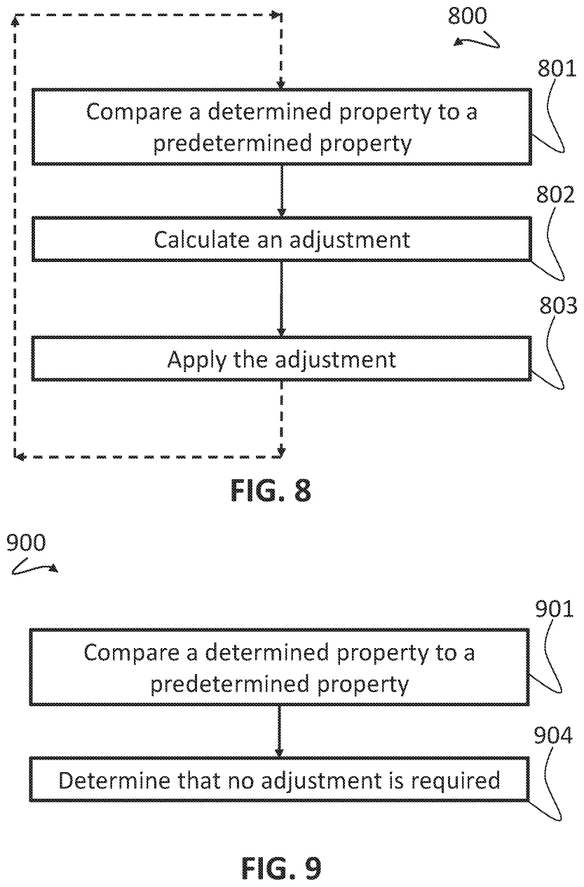

FIG. 8 is a flow diagram depicting a method 800 of calculating and applying an adjustment to a fastener setting tool and/or a work piece. At step 801, a determined property is compared to a predetermined property. At step 802, an adjustment is calculated. At step 803, the adjustment is applied.

As discussed above, the performance of a fastener setting tool may vary depending on the condition of the tool, for example if the tool is cold, warming or warm. By using the method 800, the varying performance of the tool may be compensated for. In particular, an effect of frictional losses can be indirectly determined by measuring the first parameter and comparing it to the predetermined parameter. Calculating and applying an adjustment thereon therefore provides a compensation method. Such a compensation method may beneficially improve the performance of the tool.

As indicated by the dashed line, the method 800 may be performed iteratively to form a feedback loop. That is, the steps of comparing, calculating, and applying an adjustment may be repeated any number of times for the same or successive fasteners. In this way, the method may converge on parameters for inserting a fastener to help minimize tool wear while ensuring that fasteners are inserted in accordance with predetermined properties. For example, the tool may insert fasteners to optimum head heights with the minimum necessary force.

At step 801, a determined property is compared to a predetermined property. In general, the determined property and the predetermined property may both relate to the same, or a similar property. For example, the determined property may be a determined head height of a first fastener and the determined head height may have been determined by use of the method 500. The predetermined property may be a predetermined head height. As an alternative example, the determined property may be a determined thickness of a work piece and may have been determined by use of the method 200. The predetermined property may be a predetermined thickness. As a further example, the determined property may be a determined tool deflection and may have been determined by use of the method 400. The predetermined property may be a predetermined tool deflection. As a further example, the determined property may be a determined deflection factor and may have been determined by use of the method 400.

The predetermined property may a predetermined deflection factor. The determined property may be a presence or size of a panel gap. The predetermined property may be a predetermined presence or size of a panel gap. It will be appreciated that other determined properties may be compared to other predetermined properties.

The predetermined property may be a target value of the property. For example, the predetermined head height may be a target head height for a fastener (i.e. a nominal value).

The predetermined property may have been determined at any earlier point in time. For example, the predetermined property may be loaded from a database. As an alternative example, the predetermined property may have been determined based on previous insertion of one or more fasteners.

The determined property may be based on a plurality of measurements. For example, the determined property may be an average of determined head heights, each determined head height corresponding to a different fastener. Each of the different fasteners may be at the same points on corresponding work pieces. In other words, a property of a joint on each work piece may be determined and used to determine an average. In other examples, the different fasteners may be on the same work piece.

Comparing the determined property to the predetermined property may comprise calculating a difference between the determined property and the predetermined property. The comparison may further comprise applying a threshold and/or dividing the difference by a factor. By applying a threshold, for example, the tool may determine that an adjustment is require. The threshold may correspond to a tolerance. For example, if a head height of a fastener is expected to be 0.2 mm with a tolerance of 0.02 mm, the predetermined property may be 0.2 mm and the threshold may be 0.02 mm. Thus, if a fastener has been inserted with a head height of greater than 0.22 mm or 0.18 mm, an adjustment may be determined and applied at steps 802 and 803, respectively.

A difference between the determined property and the predetermined property may represent a condition of the fastener setting tool or the work piece. The condition of the fastener setting tool may be, or comprise, a temperature, age, previous usage of tool, lubrication characteristics (e.g. amount of lubrication, temperature of lubrication), and others. The condition of the work piece may be, or comprise, a strength, ductility or a property of a fastener.

At step 802, an adjustment is calculated. In general, the adjustment may be to any characteristic upon which the determined property is dependent. For example, if the determined property is the determined head height of a fastener, the adjustment may be to a torque or force applied by the fastener setting tool. As an alternative, the adjustment may be to a velocity of a punch of a fastener setting tool.

The adjustment may be calculated to minimise a difference between the determined property and the predetermined property.

In some examples, a size of the adjustment may be calculated independent of the difference between the determined property and the pre-determined property. In other words, the adjustment may be an increment (or decrement) of a particular value, regardless of how different the determined and pre-determined property are. For example, if a fastener has a determined head height of 0.3 mm (and the predetermined head height is 0.2 mm with a tolerance of 0.02 mm), the tool may calculate that an increase in the torque applied by the fastener setting tool of 5 kN should be applied. The same increase of 5 kN may be calculated for any determined head height above 0.22 mm.

In other examples, a size of the adjustment may be calculated dependent on the difference between the determined property and the predetermined property. In other words, the difference may be used to determine the adjustment. For example, a larger adjustment may be applied for a determined head height of 0.5 mm than for a determined head height of 0.3 mm, when the predetermined head height is 0.2 mm.

At step 803, the adjustment is applied. In some examples, the adjustment may be applied automatically. That is, the fastener setting tool may apply the adjustment without any further input. In other examples, the method may further comprise outputting, on an output of the fastener setting tool, an indication of the adjustment. The method may further comprise receiving, at an input of the fastener setting tool, user input instructing the fastener setting tool to apply the adjustment and the adjustment may be applied in response to the user input. For example, the tool may determine that an adjustment should be applied and provide an indication to a user of the tool on a display. The user may instruct the tool to apply the adjustment based on input via the display or a button.

In some examples, the adjustment may be applied after inserting a first fastener and prior to inserting a second fastener. In other words, the fastener setting tool may insert the first fastener with a first set of parameters and, based on the comparison, may insert the second fastener with a second set of parameters. In other examples, the adjustment may be applied after inserting a first fastener and prior to further inserting the first fastener. In other words, the fastener setting tool may insert the first fastener with a first set of parameters and, based on the comparison, may further insert the first fastener with a second set of parameters. Put differently, the adjustment may be applied while the first fastener is being inserted.

As described above, the method 800 may be iterative. As an example, the steps of the method 800 may be each be repeated in turn until there is a change in the determined property (such that the result of the comparison between the determined property and the predetermined property is different). At this point, the tool may determine that no further adjustment is required (similar to step 904 of the method 900 described below).

Alternatively, a second adjustment may be calculated and applied. The second adjustment may be an adjustment that is the opposite of the most recent adjustment that has been applied. In other words, the second adjustment may be opposed to, and have the same magnitude as, the most recent adjustment. For example, where the most recent adjustment was a decrease to the force applied to the tool of 2 kN, the second adjustment may increase the force applied to the tool by 2 kN. Beneficially, the tool may find an optimum parameter required (at a given level of granularity for the parameter) to achieve a particular head height (or other parameter).

Additionally, a third adjustment may be applied. The third adjustment may be opposed to the second adjustment (i.e. in a same direction as the first adjustment). The third adjustment may be smaller in magnitude than the first adjustment. For example, the first adjustment may be +2 kN, the second adjustment may be −2 kN and the third adjustment may be +0.5 kN. In this way, additional iterations of the method 800 may be performed using steps of decreasing size such that an optimum parameter required (at an increasing level of granularity for the parameter) to achieve a particular head height (or other parameter).

As an alternative to the second adjustment described above, the second adjustment may be opposed to, and have a smaller magnitude, than the most recent first adjustment. For example, where the most recent adjustment was a decrease to the force applied to the tool of 2 kN, the second adjustment may increase the force applied to the tool by 0.5 kN. In other words, the first adjustment may be −2 kN and the second adjustment may be +0.5 kN. In this way, the method may continue until the magnitude of the adjustments match a particular granularity at which the tool may be adjusted.

As an example of the method 800, a rivet setting tool may insert a first fastener with a force of 85 kN to achieve a head height of 0.0 mm (i.e. the fastener may be flush). Accordingly, the tool may decrease the force applied by 2 kN. These steps may be repeated and subsequent fasteners may each be inserted with respective forces of 83 kN, 81 kN, 79 kN, and 77 kN with each subsequent fastener having a head height of 0.0 mm. The force may be reduced to 75 kN and a fastener inserted with this force may have a head height of 0.1 mm. The most recent adjustment may then be reversed and the tool may then insert fasteners with 77 kN to a head height of 0.0 mm. In this way, a minimum force may be found for inserting fasteners to a particular head height in work pieces.

The method may further comprise storing the determined parameter, the predetermined parameter, the adjustment and/or determined parameters for subsequent fasteners. The stored values may be analyzed to determine or predict if defects are present.

It will be appreciated that the steps of method 800 may be performed in any order. For example, the method 800 may begin with the step 803 of applying an adjustment to a parameter.

FIG. 9 is a flow diagram depicting a method of determining that no adjustment to a fastener setting tool and/or work piece is required. At step 901, a determined property is compared to a predetermined property. At step 904, it is determined that no adjustment is required.

The determined property may be compared to the predetermined property in a similar manner to in the method 800. In other words, step 901 may be carried out in a similar manner to step 801.

At step 904, it is determined that no adjustment is required. As discussed above in relation to step 801, comparing the determined property to the predetermined property may comprise applying a threshold to the difference. That is, if the difference is below the threshold, the tool may determine that no adjustment is required.

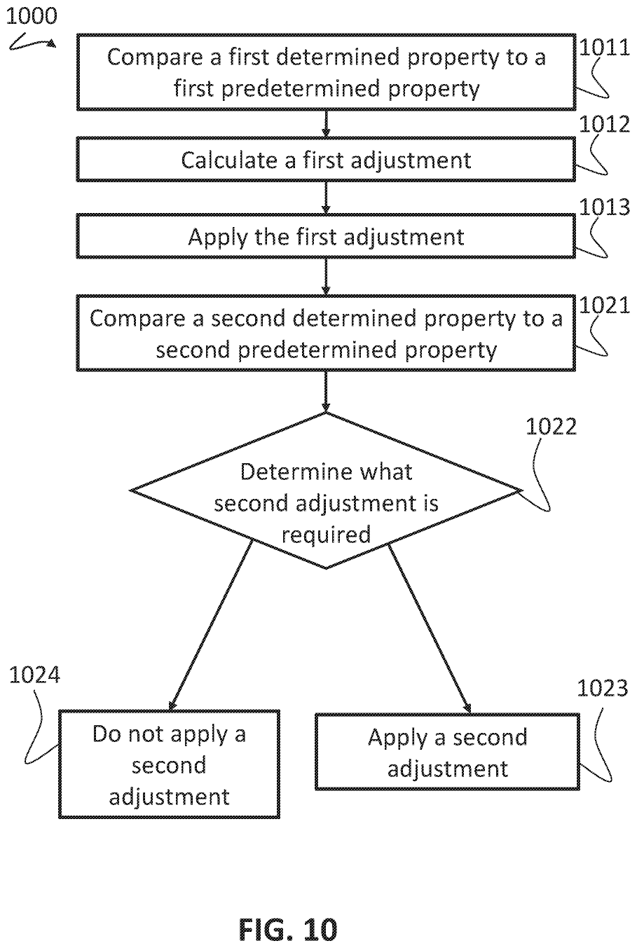

FIG. 10 is a flow diagram depicting an iterative method 1000 of calculating and applying adjustments to a fastener setting tool and/or a work piece. The iterative method 1000 is an example as to how the methods 800, 900 may be performed iteratively.

At step 1011, a first determined property is compared to a first predetermined property. At step 1012, a first adjustment is calculated. At step 1013, the first adjustment is applied. At step 1021, a second determined property is compared to a second predetermined property. At step 1022, it is determined what second adjustment is required. At step 1023, the second adjustment is applied. Alternatively, at step 1024 the second adjustment is not applied.

Each of the steps of the iterative method 1000 may be performed in a similar manner to the corresponding steps of the methods 800, 900. Determining what second adjustment is required (i.e. step 1022) may be performed in a similar manner to calculating the adjustment at step 802 and/or determining that no adjustment is required at step 904. That is, if a difference between the second determined property and second predetermined property is below a threshold, a second adjustment may not be applied. Alternatively, if the difference between the second determined property and second predetermined property is above a threshold, a second adjustment may be applied. A size of the second adjustment may be dependent on the difference, as discussed above in relation to the method 800. Alternatively, the size of the second adjustment may be independent of the difference.

It will be appreciated that the use of ‘first’ and ‘second’ in relation to the method 1000 are labels. In other words, there may be any number of first adjustments.

While terms such as ‘downwards’ or ‘top’ have been used in this specification, it should be understood that such terms are exemplary and do not imply that any particular orientation of the apparatus is essential. For example, while the rivet setting tool 2 depicted in FIG. 1 operates on a work piece W that is substantially flat and aligned with a horizontal plane, the rivet setting tool 2 may operate on a work piece W that is aligned in another manner.

It will be appreciated that the threshold tests (and corresponding actions) described herein (i.e. those described in relation to the method 200, the method 400 and the method 500) are merely exemplary and other combinations (including other threshold tests on other determined values) may be advantageous.

While the steps of the methods described herein (i.e. the method 200, the method 400 etc.) have each been described in an order, the order is not a requirement of the invention. For example, in the method 200, the position of the calibration position may be measured (at step 202) after the position of the surface of the work piece 330 has been measured (at step 204).

While the steps of the methods described herein have been described as being carried out, one or more of the methods may be implemented as computer-implemented methods. For example, one or more of the methods may be stored on computer-readable storage media which, when read by a computer, cause a fastener setting tool 310 controlled by the computer to carry out the one or methods. The computer may be referred to as a controller. It will be appreciated that in computer-implemented methods, an action may (instead of being carried out) be described as being caused to be carried out. For example in the method 200, step 201 is advancing a blank holder to a calibration position. In a computer-implemented method, the corresponding step may be causing a blank holder to advance to a calibration position.

It will be appreciated that a reference to any one of: receiving a quantity; determining a quantity; and measuring a quantity be construed likewise. For example, receiving a determined position of a top surface of the fastener may comprise determining a position of the top surface of the fastener and/or measuring the position of the top surface of the fastener.

It will also be appreciated that a reference to an energy applied to a fastener by a rivet insertion tool may likewise refer a force applied to the fastener by the rivet insertion tool. It is known that some rivet insertion tools operate by application of a torque.

References to an energy (applied by a rivet insertion tool) may likewise refer to a corresponding torque. It will likewise be appreciated that a force sensor may be alternatively referred to as an energy sensor or torque sensor (and vice versa).

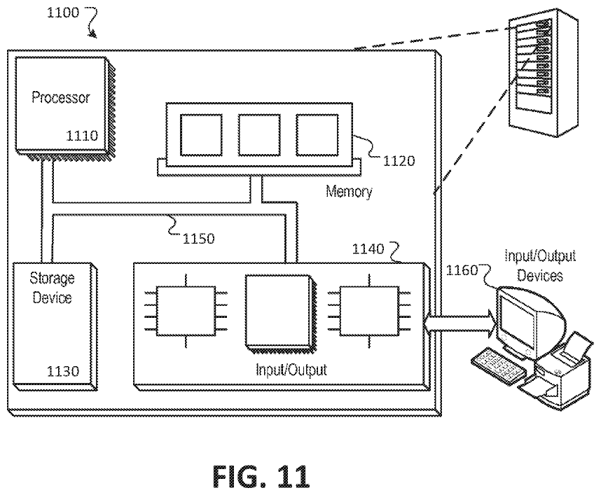

FIG. 11 shows an example computer system 1100. The computer-implemented method 100 (or any other method described herein) may be implemented on a computer system, such as the computer system 1100. The computer system 1100 may comprise a central processing unit 1110, memory 1120, one or more storage devices 1130, an input/output processor 1140, circuitry to connect the components 1050 and one or more input/output devices 1160.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a mark-up language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a track-ball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1-32. (canceled)

33. A computer-implemented method of determining a property of a fastener, the method comprising:
receiving a stored deflection factor, the stored deflection factor relating a deflection of a fastener setting tool to the peak force exerted by the fastener on a die;
receiving a determined peak force, the determined peak force corresponding to the peak force exerted by a punch of the fastener setting tool on the fastener;
receiving a determined thickness of a work piece;
receiving a determined position of a top surface of the fastener; and
determining the head height, HH, of the fastener as:
$$HH = ( DF \times PF ) - MT + ED$$
wherein:
DF is the stored deflection factor;
PF is the determined peak force;
MT is the determined thickness of the work piece; and
ED is the determined position of the top surface of the fastener.

34. The method of claim 33, wherein receiving the determined thickness of the work piece further comprises:
causing a blank holder of the fastener setting tool to advance such that the blank holder moves to a calibration position;
measuring, with a first sensor configured to measure a displacement of the blank holder, a position of the calibration position along an axis travelled by the blank holder;
causing the blank holder to advance such that the blank holder contacts a surface of the work piece and clamps the work piece against the die;
measuring, with the first sensor, a position of the surface of the work piece along the axis travelled by the blank holder; and
determining, using the measured position of the calibration position and the measured position of the surface of the work piece, a thickness of the work piece.

35. The method of claim 33, comprising applying a threshold test to the determined head height.

36. The method of claim 33, further comprising causing a punch of the fastener setting tool to insert a first fastener into the work piece.

37. The method of claim 35, further comprising determining, based on a result of the threshold test:
that the fastener setting tool requires maintenance; and/or
that the work piece should be reviewed and/or replaced; and/or
that a parameter associated with the fastener setting tool should be adjusted.

38. The method of claim 34, wherein measuring the displacement of the blank holder comprises measuring the displacement of a member of the fastener setting tool fixed relative to the blank holder.

39. The method of claim 33, further comprising:
comparing the determined property to a predetermined property, wherein a difference between the determined property and the predetermined property represents a condition of the fastener setting tool or the work piece;
calculating an adjustment based on the comparison to compensate for the condition of the fastener setting tool or the work piece; and
performing at least one of:
applying the adjustment to the fastener setting tool and/or the work piece; and
causing a punch of the fastener setting tool to insert a first fastener into the work piece.

40. The method of claim 39, wherein comparing the determined property to the predetermined property, calculating the adjustment based on the comparison, and applying the adjustment are each performed after the punch has been caused to insert the first fastener into the work piece; and
wherein the method further comprises, after the adjustment has been applied:
causing the punch to insert a second fastener into a work piece; and/or
causing the punch to further insert the first fastener into the work piece

41. The method of claim 39, wherein the adjustment is an adjustment to at least one of:
a torque and/or force applied by the fastener setting tool; and/or
a velocity of the fastener setting tool.

42. The method of claim 33, wherein the determined property is the determined head height of the first fastener and the predetermined property is a predetermined head height.

43. The method of claim 33, further comprising:
comparing the determined property to a predetermined property, wherein a difference between the determined property and the predetermined property represents a condition of the fastener setting tool and/or the work piece; and
determining, based on the comparing, that no adjustment to the fastener setting tool and/or work piece is required.

44. A computer-implemented method of determining a property of a work piece and/or a fastener setting tool, the method comprising:
causing a blank holder of the fastener setting tool to advance such that the blank holder moves to a calibration position;
measuring, with a first sensor configured to measure a displacement of the blank holder, a position of the calibration position along an axis travelled by the blank holder;
causing the blank holder to advance such that the blank holder contacts a surface of the work piece and clamps the work piece against the die;
measuring, with the first sensor, a position of the surface of the work piece;
determining, using the measured position of the calibration position and the measured position of the surface of the work piece, a thickness of the work piece.

45. The method of claim 44, further comprising:
receiving a determined position of a top surface of the fastener;
receiving a measured head height of the fastener;
determining a tool deflection, TD, corresponding in changes in end positions relative to starting positions of components of the tool due to insertion of the fastener as:
$$TD = HH + MT - ED$$
wherein:
HH is the measured head height of the fastener;
MT is the determined thickness of the work piece; and
ED is the determined position of the top surface of the fastener

46. The method of claim 45, further comprising storing the determined tool deflection.

47. The method of claim 45, further comprising:
determining a peak force exerted by the punch on the fastener; and
determining a deflection factor, DF, corresponding to a deflection of the fastener setting tool to the peak force exerted by the punch on the fastener as:
$$DF = TD \div PF$$
wherein PF is the determined peak force.

48. The method of claim 44, further comprising:
comparing the determined property to a predetermined property, wherein a difference between the determined property and the predetermined property represents a condition of the fastener setting tool or the work piece;
calculating an adjustment based on the comparison to compensate for the condition of the fastener setting tool or the work piece; and
applying the adjustment to the fastener setting tool and/or the work piece and wherein:
the determined property is the determined thickness of the work piece and the predetermined property is a predetermined thickness; or
the determined property is the determined tool deflection and the predetermined property is a predetermined tool deflection; or
the determined property is the determined deflection factor and the predetermined property is a predetermined deflection factor.

49. A fastener setting tool comprising a controller, wherein the controller is configured to perform the method of claim 33 to determine a property of a fastener.

50. The fastener setting tool of claim 49, further comprising a first sensor configured to measure a displacement of a blank holder.

51. The fastener setting tool of claim 50, further comprising a member fixed relative to the blank holder and wherein the first sensor is configured to measure the displacement of the blank holder by measuring a displacement of the member.

52. The fastener setting tool of claim 49, wherein the first sensor is a contact displacement sensor.
